(19) United States
(12) Patent Application Publication
(10) Pub. No.: US 2026/0342695 A1
(43) Pub. Date: Oct. 29, 2026

(54) END-TO-END OBSERVABILITY SYSTEM

(71) Applicant: PepsiCo Inc., Purchase, NY (US)

(72) Inventors: Latha Kurnool, Purchase, NY (US); Chaitanya Ambadipudi, Purchase, NY (US); Swaroop Krishnamurthy, Purchase, NY (US)

(21) Appl. No.: 19/659,523

(22) Filed: Apr. 27, 2026

Related U.S. Application Data
(60) Provisional application No. 63/795,101, filed on Apr. 25, 2025.

(51) Int. Cl. H04L 43/045; H04L 41/0654; H04L 41/0677; H04L 41/5003; H04L 43/02

(52) U.S. Cl. CPC H04L 43/045; H04L 41/0654; H04L 41/0677; H04L 41/5003; H04L 43/02

(57) ABSTRACT

Aspects of the present disclosure involve a system comprising a computer-readable storage medium storing a program and method for end-to-end observability across heterogeneous data platforms. The program and method provide for receiving monitoring data from a plurality of heterogeneous data platforms, the plurality of heterogeneous data platforms including at least a data pipeline platform and an infrastructure platform; enriching the received monitoring data with context information associated with the plurality of heterogeneous data platforms; storing the enriched monitoring data in a unified telemetry store that aggregates telemetry from the plurality of heterogeneous data platforms; generating, based on the enriched monitoring data stored in the unified telemetry store, an alert associated with a detected condition; and causing display, in a single view, of unified monitoring information derived from the enriched monitoring data stored in the unified telemetry store.

### PRIORITY CLAIM

This application claims the benefit of priority of U.S. Provisional Patent Application No. 63/795,101, filed Apr. 25, 2025, which is hereby incorporated by reference herein in its entirety.

### TECHNICAL FIELD

The present disclosure relates generally to an end-to-end observability system, including observing and monitoring data from across multiple heterogeneous data platforms.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram illustrating an E2E observability system, according to some examples.

FIG. 2 is a block diagram illustrating a framework of capabilities supported by an E2E observability system, according to some examples.

FIG. 3 is a proactive data management and governance diagram illustrating proactive data management and governance, according to some examples.

FIG. 4 is an E2E true north diagram illustrating purpose, guiding principles, and long-term vision for a corporation which implements the E2E observability system, according to some examples.

FIG. 5 is a benefits diagram illustrating benefits of the E2E observability system, according to some examples.

FIG. 6 is a core features diagram illustrating core features of the E2E observability system, according to some examples.

FIG. 7 is a single pane of glass diagram illustrating the E2E observability system as a single pane of glass, according to some examples.

FIG. 8 is a diagram illustrating a dashboard interface, according to some examples.

FIG. 9 is a diagram illustrating an infrastructure view user interface related to an infrastructure view, according to some examples.

FIG. 10 is a diagram illustrating a notifications user interface related to alerting and notifications, according to some examples.

FIG. 11 is a diagram illustrating an email message, according to some examples.

FIGS. 12A and 12B form a block diagram illustrating an example networked computing environment for facilitating a manufacturing process in a manufacturing environment, according to some examples.

FIG. 13 is a flowchart illustrating a process for end-to-end observability across heterogeneous data platforms, in accordance with some examples.

FIG. 14 is a diagrammatic representation of a machine in the form of a computer system within which a set of instructions may be executed for causing the machine to perform any one or more of the methodologies discussed herein, in accordance with some examples.

FIG. 15 is a block diagram showing a software architecture within which examples may be implemented.

### DETAILED DESCRIPTION

The disclosed embodiments provide a system for providing unified observability and monitoring across heterogeneous data platforms through a centralized telemetry store. The system enables end-to-end visibility of platform health, data pipeline operations, and cost management with configurable alerting and AI-driven insights.

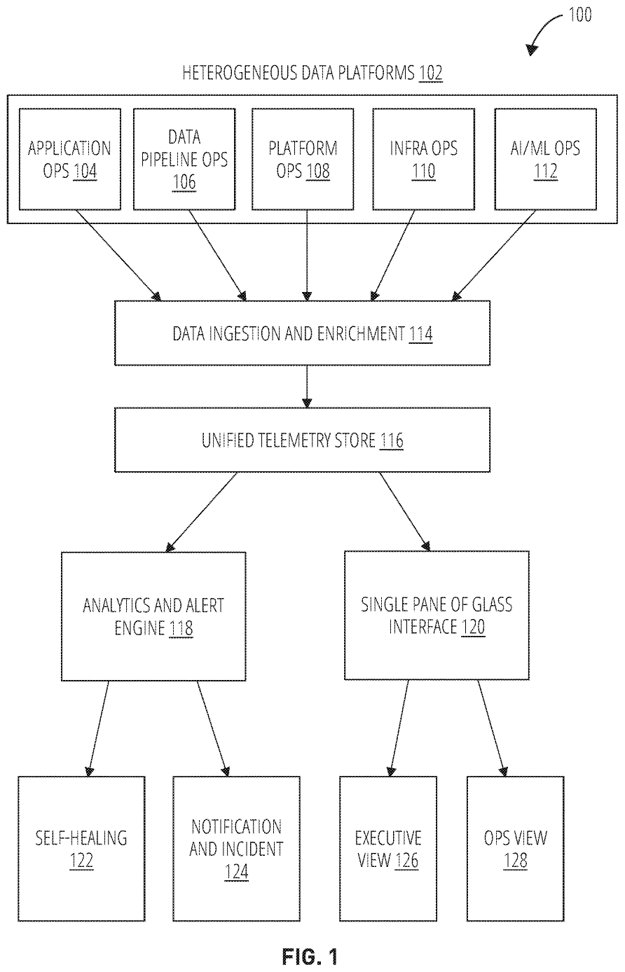

FIG. 1 illustrates an E2E observability system 100, according to some examples. The E2E observability system 100 provides a centralized architecture for monitoring data collected from across a diverse enterprise technology stack. Specifically, the E2E observability system 100 receives, enriches, stores, analyzes, and surfaces the monitoring data. The E2E observability system 100 is organized such that the monitoring data flows from multiple heterogeneous data platforms 102 through a data ingestion and enrichment layer 114. From the data ingestion and enrichment layer 114, the monitoring data flows into a unified telemetry store 116. From the unified telemetry store 116, the monitoring data flows to an analytics and alert engine 118 (e.g., downstream analytics, remediation) and a single pane of glass interface 120 (e.g., notification, and visualization components). This arrangement enables unified observability across operational domains. Without such an arrangement, the operational domains would otherwise be siloed within separate monitoring tools.

At the input layer, the E2E observability system 100 receives the monitoring data from the heterogeneous data platforms 102. The heterogeneous data platforms 102 include an application operations (OPS) data source 104, a data pipeline OPS data source 106, a platform OPS data source 108, an infrastructure (infra) OPS data source 110, and an artificial intelligence/machine learning (AI/ML) OPS data source 112.

The application OPS data source 104 provides monitoring data relating to the operational state, performance, and deployment of applications executing within the enterprise, including application health metrics, process-level indicators, and application test results. The data pipeline OPS data source 106 provides monitoring data relating to the execution, quality, and observability of data pipelines that move and transform data across the enterprise, including pipeline orchestration events, data quality metrics, metadata, and lineage information.

The platform OPS data source 108 provides monitoring data relating to the operational state and financial performance of the platforms on which applications and pipelines execute, including platform health metrics, cost and financial metrics, and deployment events. The infra OPS data source 110 provides monitoring data relating to the underlying infrastructure, including infrastructure health metrics, environment management events, and deployment events. The AI/ML OPS data source 112 provides monitoring data relating to artificial intelligence and machine learning workloads, including model deployment events, model execution telemetry, model workflow events, and interoperability and governance information.

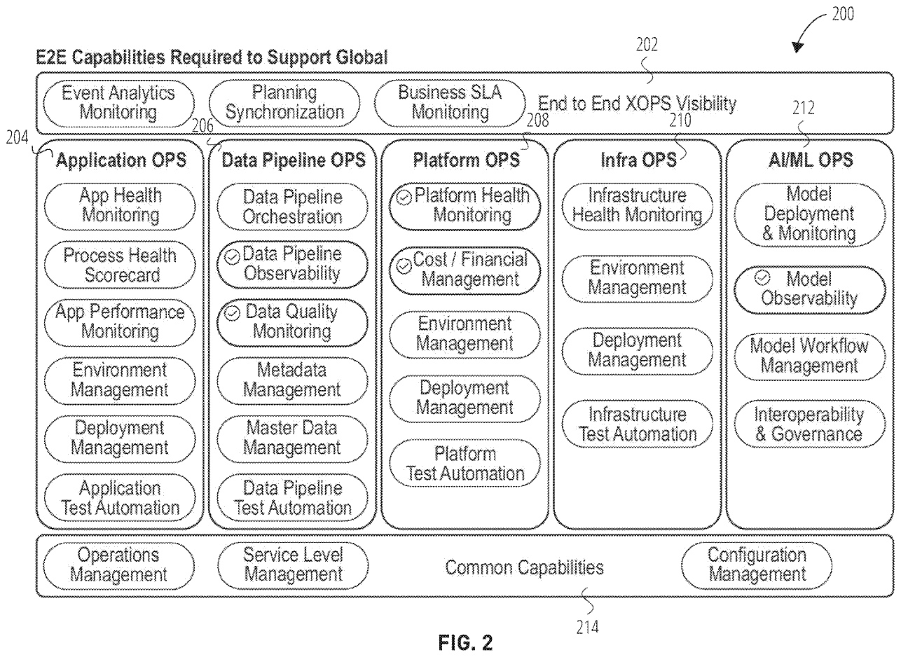

Each of the application OPS data source 104, the data pipeline OPS data source 106, the platform OPS data source 108, the infra OPS data source 110, and the AI/ML OPS data source 112 corresponds to a respective operational domain described further with respect to FIG. 2. Collectively, these data sources provide telemetry spanning application health, data pipeline operations, platform operations, infrastructure operations, and artificial intelligence and machine learning operations, respectively. The heterogeneous data platforms 102 may provide the monitoring data in real-time, near-real-time, or batch form. Accordingly, the heterogeneous data platforms 102 may include streaming data sources, batch data sources, or a combination thereof.

The monitoring data received from the heterogeneous data platforms 102 is passed to a data ingestion and enrichment layer 114. The data ingestion and enrichment layer 114 collects the monitoring data. The data ingestion and enrichment layer 114 then enriches the collected monitoring data with context information associated with the heterogeneous data platforms 102. The context information may include program-specific context information, resource tagging, ownership information, lineage metadata, or other descriptive information. Such context information enables downstream components to interpret the monitoring data in its operational context. Enrichment by the data ingestion and enrichment layer 114 thereby facilitates cross-platform correlation of events and metrics. Without such enrichment, cross-platform correlation would otherwise be difficult to perform due to the heterogeneity of the underlying data sources.

The enriched monitoring data output by the data ingestion and enrichment layer 114 is stored in a unified telemetry store 116. The unified telemetry store 116 aggregates telemetry from the heterogeneous data platforms 102 into a centralized repository. This centralized repository enables unified logging and unified analytics across the enterprise. The unified telemetry store 116 serves as a common data substrate for downstream components. The downstream components include, for example, analytics components, alerting components, and visualization components. Each of the downstream components may access the enriched monitoring data through the unified telemetry store 116. Accordingly, the downstream components do not separately integrate with each of the heterogeneous data platforms 102.

An analytics and alert engine 118 receives the enriched monitoring data from the unified telemetry store 116. The analytics and alert engine 118 applies configurable rules to the enriched monitoring data in order to detect conditions of interest. Examples of such conditions include service level agreement (SLA) violations, anomalies, cost trend deviations, growth trend deviations, and other conditions. Upon detecting a condition, the analytics and alert engine 118 generates an alert associated with the detected condition. The analytics and alert engine 118 may further track data lineage of the monitoring data across multiple hops within the heterogeneous data platforms 102. Based on the tracked data lineage, the analytics and alert engine 118 may identify a source of the detected condition.

The analytics and alert engine 118 further implements an early warning system that generates predictive alerts prior to threshold breaches or detectable anomalies. The early warning system applies trend analysis, leading indicators, and predictive signals derived from the enriched monitoring data stored in the unified telemetry store 116 to forecast conditions of interest before they occur. By generating predictive alerts in advance of threshold breaches, the early warning system enables proactive intervention across data operations and platform operations. In example embodiments, the early warning system leverages machine learning models trained on historical telemetry to identify patterns indicative of emerging conditions, including cost deviations, growth deviations, usage deviations, and pipeline delays. The analytics and alert engine 118 further includes one or more AI agents that autonomously identify root causes of detected conditions in multi-system environments. The one or more AI agents correlate events, traces, and metrics across the heterogeneous data platforms 102, traverse data lineage, and determine a probable root cause of a detected condition. The one or more AI agents may operate individually or in coordination to address root cause analysis scenarios spanning multiple operational domains.

The E2E observability system 100 further includes a self-healing module 122 and a notification and incident module 124. Each of the self-healing module 122 and the notification and incident module 124 receives output from the analytics and alert engine 118. The self-healing module 122 executes an automated self-healing action to remediate a detected condition. In some examples, the automated self-healing action executed by the self-healing module 122 includes scaling up application workloads by allocating additional compute resources. In other examples, the automated self-healing action includes restarting a failed component, re-running a failed job, or performing another remediation action. The notification and incident module 124 automatically generates an incident ticket based on a detected condition. The notification and incident module 124 also transmits notifications through a plurality of configurable channels. The configurable channels include email notifications, chat notifications (e.g., MS Teams, Slack, Zoom, or other communication and messaging applications), and notifications routed to an incident management system.

Enriched monitoring data stored in the unified telemetry store 116 is also provided to a single pane of glass interface 120. The single pane of glass interface 120 causes display, in a single view, of unified monitoring information derived from the enriched monitoring data. The single pane of glass interface 120 filters the unified monitoring information based on a user role. By filtering based on the user role, the single pane of glass interface 120 provides role-appropriate views of the unified monitoring information. Specifically, the single pane of glass interface 120 provides an executive view 126 and an operations view (OPS view) 128. The executive view 126 surfaces high-level metrics, trends, and strategic indicators suitable for executive oversight. The OPS view 128 surfaces operational details, job-level statuses, and remediation-relevant information suitable for operations personnel. In some examples, the single pane of glass interface 120 dynamically adapts the executive view 126 and the OPS view 128 based on evolving staffing, project responsibilities, or organizational roles.

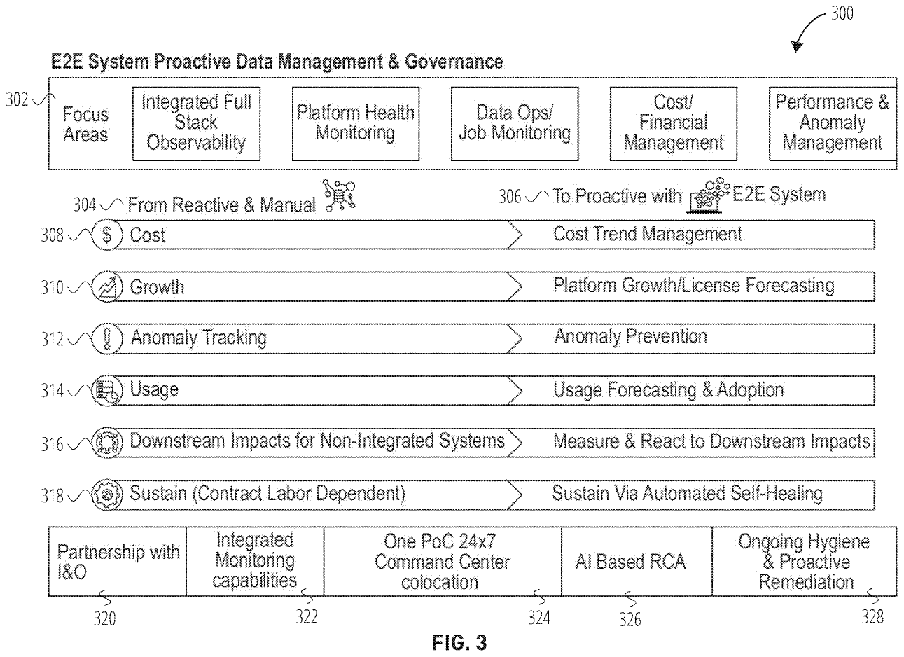

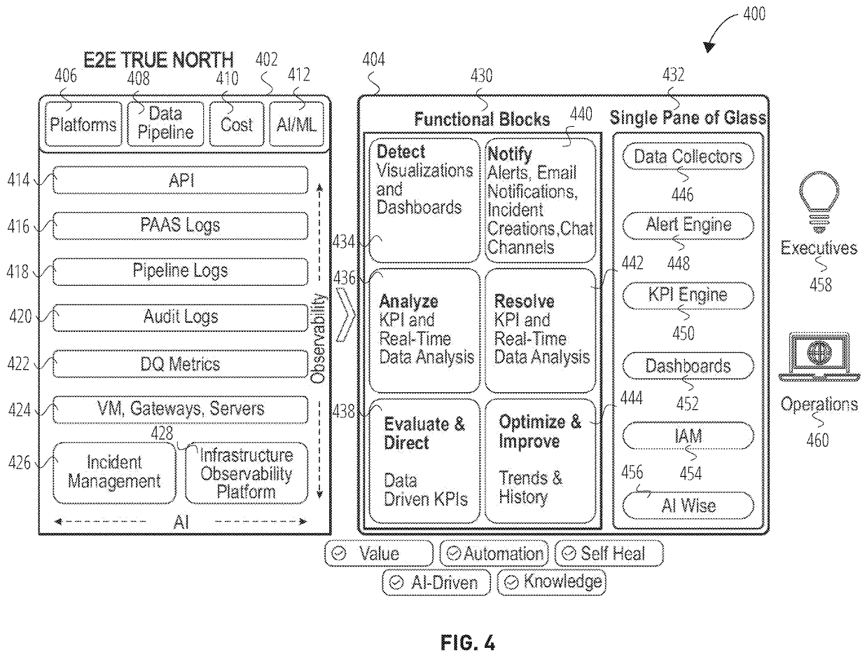

The various components depicted in FIG. 1 (e.g., implemented across servers, client devices, systems, subsystems, and the like) are able to communicate and exchange data with one another via a network. For example, the data exchanged between the components includes functions (e.g., commands to invoke functions) as well as payload data. The architecture illustrated in FIG. 1 provides the foundation for the more detailed frameworks and user interfaces described in the subsequent figures. These subsequent figures include the capability framework of FIG. 2, the proactive data management and governance diagram of FIG. 3, and the single-pane-of-glass implementations described with respect to FIGS. 4, 6, and 7.

FIG. 2 is a block diagram illustrating a framework of capabilities supported by an E2E observability system 200, according to some examples. The E2E observability system 200 generally corresponds to the E2E observability system 100 of FIG. 1. FIG. 2 expands upon the heterogeneous data platforms 102 introduced in FIG. 1 by detailing the operational domains from which the E2E observability system 100 of FIG. 1 receives monitoring data. Accordingly, the application OPS data source 104, data pipeline OPS data source 106, platform OPS data source 108, infra OPS data source 110, and AI/ML OPS data source 112 of FIG. 1 correspond respectively to the application OPS domain 204, data pipeline OPS domain 206, platform OPS domain 208, infrastructure OPS domain 210, and AI/ML OPS domain 212 of FIG. 2. In example embodiments, the example E2E observability system 200 of FIG. 2 illustrates event analytics monitoring, planning synchronization, and business service level agreement (SLA) monitoring. The E2E observability system 200 represents the E2E capabilities required to support global operations and provides an end-to-end XOPS visibility framework 202 spanning the operational domains described below.

As shown in the example of FIG. 2, the E2E observability system 200 depicts five operational areas, or domains, including: the application OPS domain 204 (e.g., app health monitoring, process health scorecard, app performance monitoring, application test automation, environment management, and deployment management); the data pipeline OPS domain 206 (e.g., data pipeline orchestration, data pipeline observability, data quality monitoring, metadata management, master data management, and data pipeline test automation); the platform OPS domain 208 (e.g., platform health monitoring, cost/financial management, environment management, deployment management, and platform test automation); the infrastructure OPS domain 210 (e.g., infrastructure health monitoring, environment management, deployment management, and infrastructure test automation); and the AI/ML OPS domain 212 (e.g., model deployment and monitoring, model observability, model workflow management, and interoperability and governance). Moreover, the E2E observability system 200 depicts a common capabilities grouping 214 that includes common capabilities such as operations management, service level management, and configuration management.

The application OPS domain 204 provides observability and control over applications executing within the enterprise. Within the application OPS domain 204, app health monitoring tracks the operational state of applications; the process health scorecard aggregates process-level indicators into a summary view; app performance monitoring tracks performance metrics; application test automation executes automated tests against applications; environment management administers the application execution environments; and deployment management coordinates the deployment of application changes.

The data pipeline OPS domain 206 provides observability and control over data pipelines that move and transform data across the enterprise. Within the data pipeline OPS domain 206, data pipeline orchestration coordinates the execution of pipeline stages; data pipeline observability surfaces pipeline telemetry; data quality monitoring evaluates data against quality rules; metadata management administers descriptive information about data assets; master data management administers reference data used across pipelines; and data pipeline test automation executes automated tests against the pipelines.

The platform OPS domain 208 provides observability and control over the platforms on which applications and pipelines execute. Within the platform OPS domain 208, platform health monitoring tracks the operational state of platform components; cost/financial management tracks platform-related cost and financial metrics; environment management administers the platform environments; deployment management coordinates deployment of platform changes; and platform test automation executes automated tests against the platforms.

The infrastructure OPS domain 210 provides observability and control over the underlying infrastructure. Within the infrastructure OPS domain 210, infrastructure health monitoring tracks the operational state of infrastructure components; environment management administers the infrastructure environments; deployment management coordinates deployment of infrastructure changes; and infrastructure test automation executes automated tests against the infrastructure.

The AI/ML OPS domain 212 provides observability and control over artificial intelligence and machine learning workloads. Within the AI/ML OPS domain 212, model deployment and monitoring coordinates deployment of models and tracks their operational state; model observability surfaces telemetry associated with model execution; model workflow management coordinates the stages of model development and use; and interoperability and governance administers compliance and integration requirements associated with models.

The common capabilities grouping 214 extends across the application OPS domain 204, the data pipeline OPS domain 206, the platform OPS domain 208, the infrastructure OPS domain 210, and the AI/ML OPS domain 212. Operations management within the common capabilities grouping 214 coordinates operational activities across the domains; service level management administers service level commitments across the domains; and configuration management administers configuration information across the domains. The end-to-end XOPS visibility framework 202 provides a unifying context across the operational domains 204, 206, 208, 210, and 212 and the common capabilities grouping 214, enabling event analytics monitoring, planning synchronization, and business SLA monitoring across the enterprise.

The various components depicted in FIG. 2 (e.g., implemented across servers, client devices, systems, subsystems, and the like) are able to communicate and exchange data with one another via a network. For example, the data exchanged between the components include functions (e.g., commands to invoke functions) as well as payload data.

In example embodiments, the E2E observability system 200 is implemented by a large-scale corporation which relies on system performance, technologies, and operations for observability. The E2E observability system 200 is configured to handle the breadth and diversity of the technology stack associated with large-scale corporations. Vendors typically offer solutions limited to their specific technology scope. The E2E observability system 200 is technology-agnostic, managing large-scale observability with core capabilities to monitor performance, cost, pipelines, and operational metrics critical for a large enterprise. However, it can be tailored to specific applications and enterprise scenarios like consumer products and goods (CPG), foods, beverages, pharmaceuticals, manufacturing, etc.

The architecture flow of FIG. 2 illustrates end-to-end observability for a heterogeneous ecosystem. The E2E observability system 200 serves various user personas, from executives to operations personnel. Through the end-to-end XOPS visibility framework 202, the E2E observability system 200 integrates platform and data pipeline observability provided by the platform OPS domain 208 and the data pipeline OPS domain 206, FinOps capabilities provided in part through cost/financial management within the platform OPS domain 208, ML/AI observability provided by the AI/ML OPS domain 212, and data availability monitoring provided by the data pipeline OPS domain 206. In large corporations employing conventional systems, even if pipelines appear healthy, data availability issues can arise.

The E2E observability system 200 provides a 360-degree view of data health by integrating real-time or near-real-time data from streaming or batch sources. The E2E observability system 200 ingests data, enriches it based on program-specific requirements, and provides customized dashboards. The ingestion and enrichment functions leverage the data pipeline OPS domain 206, while the customized dashboards surface information from across the application OPS domain 204, the platform OPS domain 208, the infrastructure OPS domain 210, and the AI/ML OPS domain 212, as well as from the data pipeline OPS domain 206 itself.

In large-scale ecosystems, data often takes multiple hops, for example, sometimes five or six hops. In conventional systems, teams at the final hop had no insight into issues originating earlier. With the E2E observability system 200, data lineage identifies problem sources, and automated incident management creates tickets or sends alerts via communication platforms (e.g., MS Teams, Slack, Zoom, email, or other communication and messaging applications), based on business preferences. The data lineage and automated incident management functions are supported by the data pipeline OPS domain 206 and the common capabilities grouping 214 (including operations management). Moreover, the issues associated with heterogenous data and multiple hops are not isolated to enterprise architectures within large companies. Rather, the issues, and the solutions discussed herein can extend to any complex data environment where uniform platforming and automation would be helpful.

In example embodiments, the E2E observability system 200 stores all telemetry in a unified metric store, enabling unified logging from diverse sources across the application OPS domain 204, the data pipeline OPS domain 206, the platform OPS domain 208, the infrastructure OPS domain 210, and the AI/ML OPS domain 212. The E2E observability system 200 offers self-serve features for key performance indicators (KPIs) and alerts, allowing teams to set custom thresholds (e.g., a job missing an SLA by 15 minutes triggers a critical incident). Such SLA thresholds are administered through service level management within the common capabilities grouping 214. Multiple alerting channels and dashboards cater to executives (e.g., data footprint, system performance, costs) and operations (e.g., critical job status). The E2E observability system 200 can also implement or leverage AI capabilities, like chatbots and self-healing as described herein, which are supported in part by the AI/ML OPS domain 212. In another embodiment, alerting channels and dashboard cater to various functions, levels of seniority, or levels of responsibility. For example, alerting channels and dashboards can cater to personnel responsible for a certain product, project, or sector and this can be dynamically adapted as the relevant project and staffing evolve. For example, as staffing changes, the alerting channels and dashboards can change. Moreover, as part of the reflective nature of the AI technology, in other embodiments, strategic and more efficacious staffing can be suggested. For example, staffing can dynamically adapt to leverage personnel who have worked on similar projects, or who have be in the same office or region, or to build skillsets by assigning personnel who have not worked on a particular type of project.

In large-scale enterprises, integrating heterogeneous data is critical. For example, a Research and Development (R&D) team's Product Lifecycle Management (PLM) initiative relies on a universal data source to streamline sourcing. This can help in R&D, supply, and procurement context by preventing issues like sourcing the same ingredient from multiple suppliers, which increases costs. Or it could strategically source materials from multiple sources as another way of, e.g., reducing costs, minimizing the environmental impact, and optimizing logistics. For example, while one supplier may charge more for a particular ingredient, the higher material cost could be offset by the environmental benefits, logistical efficiencies, and reducing shipping costs associated with a closer supplier. The E2E observability system 200 addresses these integration challenges, reducing cost overruns and delays, particularly in PLM contexts and in contexts where single or unified data sources would be beneficial. To highlight scale, and by way of non-limiting example, a large-scale corporate may manage approximately 50-70 petabytes of data within its heterogeneous system.

In this regard, the E2E observability system 200 aids data contextualization, crucial for training models across heterogeneous sources via the AI/ML OPS domain 212. For example, R&D teams may procure fewer or small-scale ingredients optimal for experimentation with data on procurement and EU testing for assembly line compatibility. Manufacturing data (e.g., sensor data associated with a bottling plant or a food processing plan) includes processing and procurement. For example, with a billion daily product consumptions, scale-up is critical. Using the example of potato chips, KPIs may cover everything from potato seed performance to selling chips across different parts of the world (e.g., Chicago, Seattle, Kuala Lumpur, and the like).

R&D functions and teams may need to look years ahead (e.g., 3 to 10 years a head), while other functions may focus on different timeframes, and a large-scale corporation must support every team and function, such as procurement, legal, and software licensing. For example, KPIs for potato chips can include potato seed quality, peeling, slicing, cooking temperature, to packaging optimization. For potato chips or other types of chips, chip size could impact a number of factors and KPIs including consumer satisfaction, environmental impact, and packaging efficiency. For soda, sweetener and other ingredient interactions, bottle storage, and logistics (e.g., how various beverages with various formulations and ingredients interact with, e.g.: (1) different bottles, with their own varying characteristics like compositions, barrier layers, weights; (2) storage conditions that can vary across the globe with factors like ambient temperature, warehouse temperature; and (3) shipping and logistics, such as whether or not a delivery truck is refrigerated) matter. The enterprise would also seek to avoid foggy or occluded beverages that would look displeasing to consumers or allergen traces (e.g., gluten in a gluten free processing area, or nuts in a nut-free processing area) to prevent recalls. Indeed, cleanliness, disinfection, and sterility are critical in food and beverage processing environments and require the careful balancing of a large number of factors, sensor data and other data that is gathered, monitored, and analyzed from processing plants and warehouses on a global scale. KPIs cover sourcing, processing, logistics, and consumer feedback, optimizing value across the global supply chain. The E2E observability system 200 as described herein is configured to account for KPIs with respect to this level of granularity, and such KPIs are surfaced and monitored through the end-to-end XOPS visibility framework 202 in coordination with service level management within the common capabilities grouping 214.

In example embodiments, the E2E observability system 200 supports various operations, for example, data pipeline operations via the data pipeline OPS domain 206, platform observability via the platform OPS domain 208, and AI/ML observability via the AI/ML OPS domain 212. This demonstrates its integration into global IT frameworks. For example, platforms encompass data pipelines and other systems. The E2E observability system 200 unifies data from these sources, adds cost tracking (e.g., cloud-based service resource tagging) via cost/financial management within the platform OPS domain 208, and trains ML models for AI capabilities via the AI/ML OPS domain 212.

FIG. 3 is a proactive data management and governance diagram 300 illustrating proactive data management and governance, according to some examples. The example of FIG. 3 shows a focus areas grouping 302 such as integrated full stack observability, platform health monitoring, data OPS/job monitoring, cost/financial management, performance and anomaly management. In addition, FIG. 3 depicts a transformation table showing a reactive and manual state 304 to a proactive state 306 for items including: a cost item 308 transitioning from cost to cost trend management; a growth item 310 transitioning from growth to platform growth/license forecasting; an anomaly tracking item 312 transitioning from anomaly tracking to anomaly prevention; a usage item 314 transitioning from usage to usage forecasting and adoption; a downstream impacts item 316 transitioning from downstream impacts for non-integrated systems to measure and react to downstream impacts; and a sustain item 318 transitioning from sustain (contract labor dependent) to sustain via automated self-healing. FIG. 3 further depicts a partnership with I&O block 320, an integrated monitoring capabilities block 322, a one PoC 24×7 command center colocation block 324, an AI-based RCA block 326, and an ongoing hygiene and proactive remediation block 328.

Cost trend management associated with the cost item 308 is critical in many business contexts, including for global CPGs where consumer costs must be minimized while global CPG companies may have to produce billions of product units a day while: (1) seeking to ensure each consumer interaction is positive; (2) sourcing ingredients and packaging; (3) optimizing logistics; (4) striving to achieve a positive environmental impact; (5) staffing appropriately; (6) ensuring compliance with varying legal requirements and internal governance standards, which may be more rigorous; and (7) tracking, analyzing, and processing a large volume of data across the globe on a real-time and historical basis.

In IT environments, five critical frameworks of application OPS, data pipelines, platform, FinOps/Infra OPS, and AI/ML are essential and are represented collectively in the focus areas grouping 302 of the proactive data management and governance diagram 300. The proactive data management and governance diagram 300 explains how the E2E observability system 200 shifts a corporation from the reactive and manual state 304 to the proactive state 306 of operations, as reflected across the cost item 308, the growth item 310, the anomaly tracking item 312, the usage item 314, the downstream impacts item 316, and the sustain item 318.

In conventional systems, teams may track costs (e.g., labor, hardware, software) in siloed spreadsheets. The E2E observability system 200 consolidates these into a product catalog, including license details, and sends proactive alerts (e.g., 90/60/30-day license renewal reminders) in support of the cost item 308 and the growth item 310 of the proactive data management and governance diagram 300. For example, this ensures owners are prepared financially.

Moreover, resource mapping links assets to owners and programs, providing clear cost insights consistent with the cost item 308. The E2E observability system 200 also tracks storage growth trends reflected by the growth item 310 and detects anomalies reflected by the anomaly tracking item 312 (e.g., a sudden 60% data growth versus 20% previously). Automated self-healing associated with the sustain item 318 and AI-based root cause analysis associated with the AI-based RCA block 326 address issues proactively. The E2E observability system 200 is configured to collaborate with a company's infrastructure team, consistent with the partnership with I&O block 320 and the integrated monitoring capabilities block 322, to integrate observability, offering a 460-degree view of infrastructure, platforms, and pipelines in one dashboard, further supported by the one PoC 24×7 command center colocation block 324 and the ongoing hygiene and proactive remediation block 328.

In example embodiments, the E2E observability system 200 calculates trends for cost (see cost item 308) and growth (see growth item 310) over a predefined time period (e.g., 6 to 12 months), which may be absent in other systems. The E2E observability system 200 also handles tight coupling across heterogeneous systems, stitching them together for trend analysis, including trend analysis associated with the anomaly tracking item 312, the usage item 314, and the downstream impacts item 316 of the proactive data management and governance diagram 300.

By way of non-limiting example, producing a potato chip involves multiple data sources such as but not limited to: procuring seeds for a grower, environmental, farming/agricultural, shipping the potatoes to a processing plant, peeling, cutting, and cooking and bagging the potatoes in a processing line that requires facilities that are hundreds of square meters (e.g., 180 to 800 square meters). For bottling, facilities can be as large as 5,000 to 10,000 square meters (e.g., approximately the size of one to two professional football fields). Supply chain data, like sourcing bottles or packaging materials, staffing, warehouse optimization, and last-mile logistics, all require integration. Such integration is consistent with the focus areas grouping 302 of the proactive data management and governance diagram 300 and with the transition from the reactive and manual state 304 to the proactive state 306 across the cost item 308, growth item 310, anomaly tracking item 312, usage item 314, downstream impacts item 316, and sustain item 318.

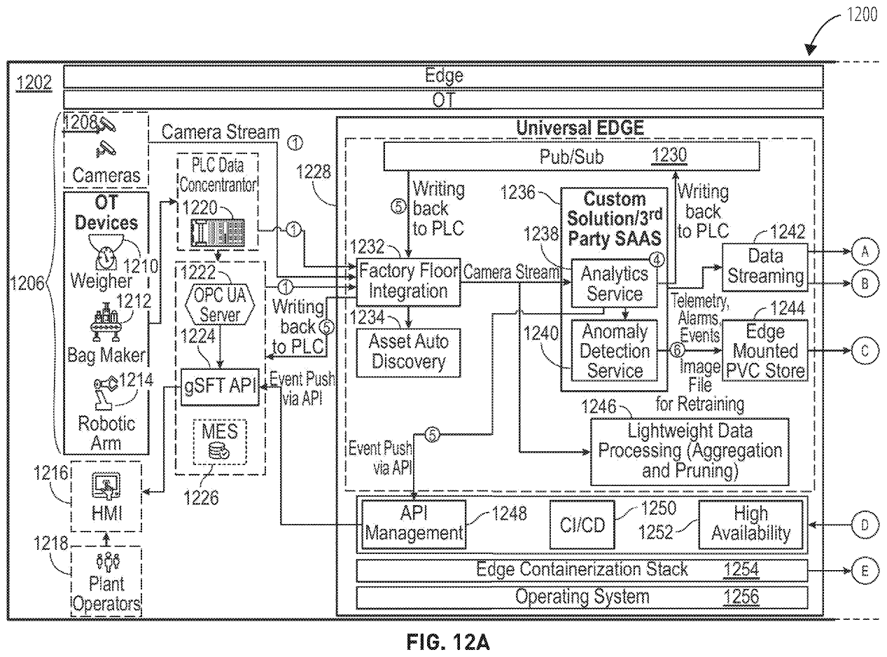

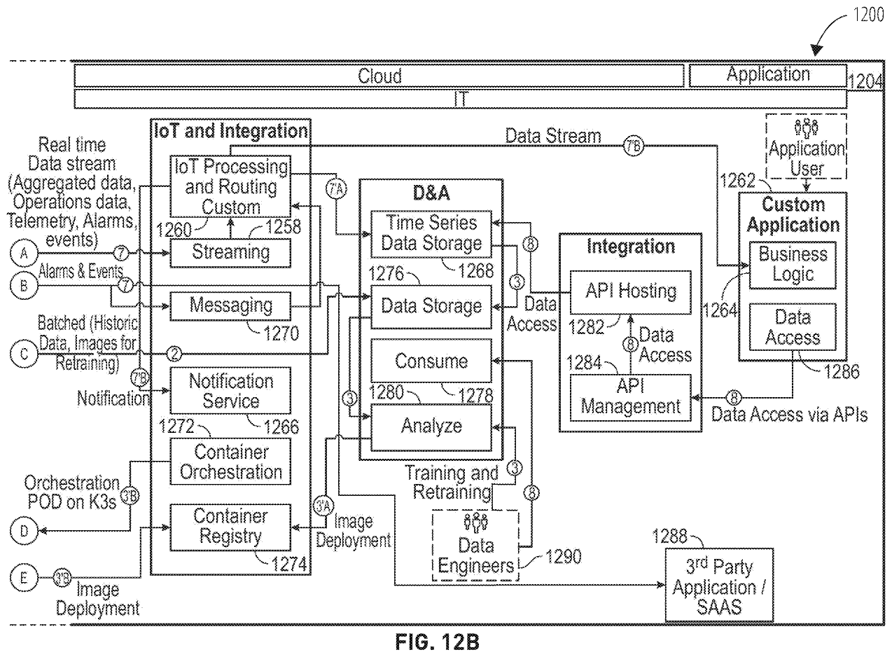

The E2E observability system 200 stitches these together. For example, FIGS. 12A-12B discussed further below illustrate a manufacturing system corresponding to at least one of the above-noted data sources. The stitching function is supported in practice by the integrated monitoring capabilities block 322 and the partnership with I&O block 320 of the proactive data management and governance diagram 300, with ongoing maintenance and quality provided by the ongoing hygiene and proactive remediation block 328.

The E2E observability system 200 is not limited to these use cases, and can also apply to optimizing shipment schedules among other things. Additional use cases, like AI-driven features, may be critical. The E2E observability system 200's scalability and trend analysis are key to such use cases, and are leveraged in connection with the AI-based RCA block 326 and the one PoC 24×7 command center colocation block 324 of the proactive data management and governance diagram 300.

For example, supply chain operations rely on daily IT data for sales, finance, transportation, demand, and production. A 15-minute delay may impact multiple users (e.g., 1400 users) and thousands of spreadsheets, a number of databases, and other record documents. The E2E observability system 200 proactively identifies issues (e.g., a problem at hop 3) and alerts teams, preventing delays, consistent with the proactive state 306 and the downstream impacts item 316 of the proactive data management and governance diagram 300.

By way of non-limiting example, North American (NA) Supply Chain Business receives data every day from the IT for the following 6 domains: (1) Demand; (2) Production; (3) Inventory; (4) Sales; (5) Transport; and (6) Purchase. These domains are monitored through the focus areas grouping 302 of the proactive data management and governance diagram 300 to maintain the proactive state 306.

If there is any delay in the above business data, the impact is very critical. For example, critical dashboards impacted include but are not limited to: daily inventory analysis (DIA) and the trend dashboard, where the trend dashboard is an all encompassing supply chain report. The DIA and the trend dashboard are both used for analyzing the current status of the supply chain including demand planning, supply planning, inventory, sales, manufacturing, and transportation movements. Such delays are surfaced through the integrated monitoring capabilities block 322 of the proactive data management and governance diagram 300 and addressed via the AI-based RCA block 326 and the ongoing hygiene and proactive remediation block 328.

Regarding further impact of delay, the number of users depending on these data refresh is typically large (e.g., 1700+). Moreover, there may be approximately 800+ spreadsheet connections directly mapping to supply chain operations on the ground, and at least 6+ data analysis and visualization reports generated by, for example, programs such as Power BI, Tableau, Qlik Sense, AWS QuickSight, Google Data Studio, Domo, and others. The resulting dependency footprint is consistent with the downstream impacts item 316 and is managed through the proactive state 306 of the proactive data management and governance diagram 300.

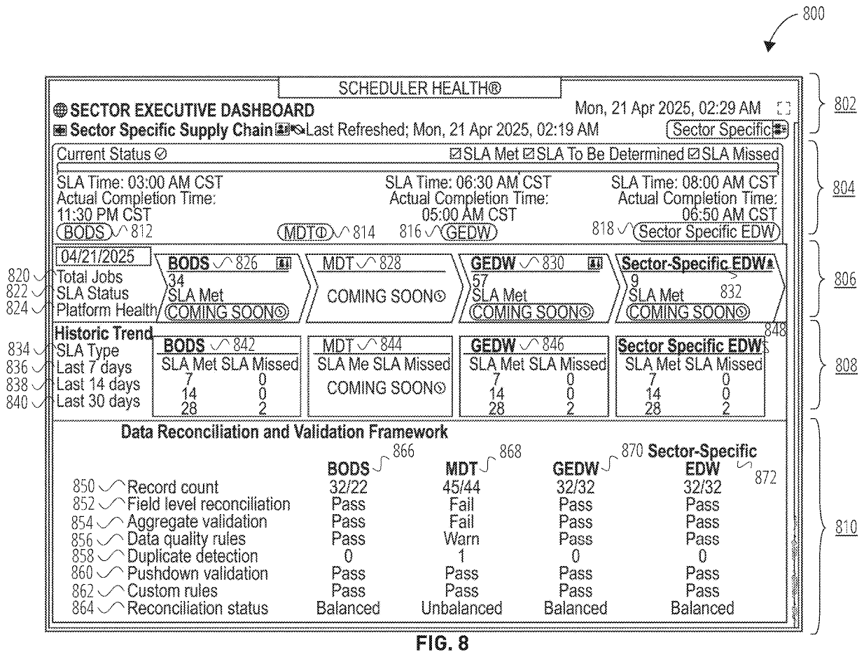

Thus, if there are any data delays or pipeline failures in any hops (e.g., see FIG. 8 discussed below), the E2E observability system 200 will proactively send alerts to notify the business of the issue, consistent with the proactive state 306 of the proactive data management and governance diagram 300 and supported by the integrated monitoring capabilities block 322, the one PoC 24×7 command center colocation block 324, the AI-based RCA block 326, and the ongoing hygiene and proactive remediation block 328.

FIG. 4 is an E2E true north diagram 400 illustrating purpose, guiding principles, and long-term vision for a corporation which implements the E2E observability system 200, according to some examples. Whereas FIG. 1 depicts the architectural arrangement of the E2E observability system 100 and FIG. 2 depicts the operational domains from which the E2E observability system 200 receives monitoring data, FIG. 4 depicts how the data flowing through those operational domains is consumed, analyzed, and surfaced to end users. In this manner, FIG. 4 builds upon the capability framework of FIG. 2 and the proactive data management and governance diagram 300 of FIG. 3. FIG. 4 maps the upstream data sources to downstream functional blocks and to a single-pane-of-glass presentation layer.

The E2E true north diagram 400 shows how the E2E observability system 200 provides a single-pane-of-glass view for executives and operations. The E2E true north diagram 400 is organized into a tier 402 and a tier 404 that together provide observability across the enterprise. The tier 402 represents the upstream data and telemetry sources from which monitoring data is collected. The tier 404 represents the downstream functional blocks and presentation components through which the collected monitoring data is transformed into actionable output.

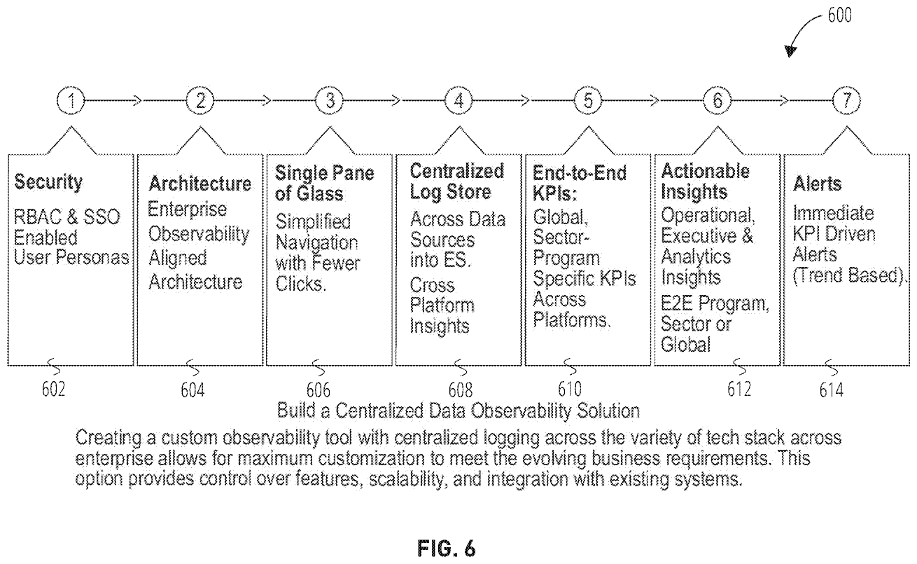

The E2E observability system 200 unifies logs from platforms, application programming interfaces (APIs), pipelines, audits, and data quality (DQ) metrics. Based on the unified logs, the E2E observability system 200 offers visualizations, dashboards, and alerts tailored to user personas. As shown in the example of FIG. 4, key performance indicators (KPIs) play an important role with respect to the E2E observability system 200. The KPIs surfaced through the tier 404 correspond to the end-to-end KPIs described with respect to FIG. 6 and the business SLA monitoring described with respect to FIG. 2.

Within the tier 402 of the E2E true north diagram 400, data sources are represented by a platforms block 406, a data pipeline block 408, a cost block 410, and an artificial intelligence/machine learning (AI/ML) block 412. The platforms block 406, data pipeline block 408, cost block 410, and AI/ML block 412 correspond to the operational domains 204, 206, 208, and 212 depicted in FIG. 2, respectively. Additional telemetry sources within the tier 402 are represented by an API block 414, platform-as-a-service (PAAS) logs 416, pipeline logs 418, audit logs 420, DQ metrics 422, a virtual machine (VM), gateways, servers block 424, an incident management block 426, and an infrastructure observability platform block 428. These additional telemetry sources supply the granular log, metric, and event data that the data ingestion and enrichment module 114 of FIG. 1 collects, enriches, and forwards to the unified telemetry store 116 of FIG. 1.

FIG. 4 further depicts a functional blocks grouping 430 of the E2E true north diagram 400. The functional blocks grouping 430 includes a detect block 434 to detect (e.g., visualizations and dashboards), a notify block 440 to notify (e.g., alerts, email notifications, incident creations, chat channels), an analyze block 436 to analyze (e.g., KPI and real-time data analysis), and a resolve block 442 to resolve (e.g., KPI and real-time data analysis). The functional blocks grouping 430 further includes an evaluate and direct block 438 to evaluate and direct, and an optimize and improve block 444 to optimize and improve. The functional blocks grouping 430 operates on the enriched monitoring data stored in the unified telemetry store 116 of FIG. 1. The functional blocks grouping 430 corresponds to the analytics and alert engine 118, the self-healing module 122, and the notification and incident module 124 of FIG. 1.

In addition, FIG. 4 depicts a single pane of glass grouping 432 of the E2E true north diagram 400. The single pane of glass grouping 432 includes a data collectors module 446, an alert engine 448, a KPI engine 450, a dashboards module 452, an IAM module 454, and an AI wise module 456. The single pane of glass grouping 432 corresponds to the single pane of glass interface 120 of FIG. 1. The single pane of glass grouping 432 and the functional blocks grouping 430 together serve an executives persona 458 and an operations persona 460. Each persona is provided with role-appropriate visibility, alerting, and analysis, consistent with the executive view 126 and OPS view 128 of FIG. 1.

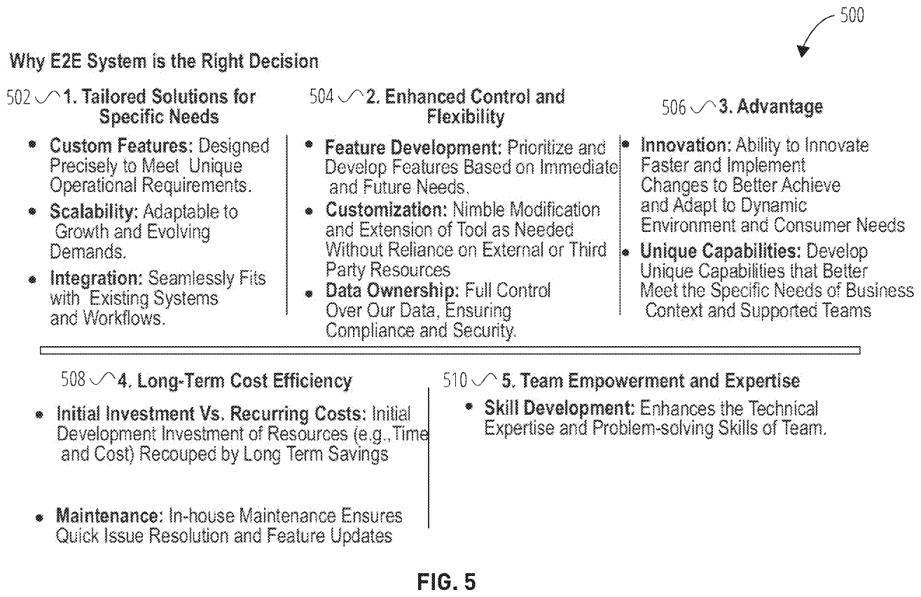

FIG. 5 is a benefits diagram 500 illustrating benefits of the E2E observability system 200, according to some examples. Whereas FIGS. 1-4 describe the architecture, operational domains, proactive data management approach, and purpose of the E2E observability system 200, FIG. 5 describes the benefits that follow from the implementations shown in those prior figures. For example, the benefits diagram 500 is titled “Why E2E System is the Right Decision” and depicts why the E2E observability system 200 is the right solution.

A large-scale corporation's data grows exponentially, and new technologies (e.g., ADF, EDF frameworks) are constantly added. The E2E observability system 200′s unified telemetry store simplifies observability. The unified telemetry store offers a scalable, tailored solution for any data source, consistent with a tailored solutions for specific needs grouping 502 of the benefits diagram 500. The tailored solutions for specific needs grouping 502 includes custom features designed precisely to meet unique operational requirements, scalability adaptable to growth and evolving demands, and integration that seamlessly fits with existing systems and workflows.

A common issue with conventional systems is that the development process requires surges in staffing and/or external sourcing. For example, this leads to staffing uncertainty, slower development times, inefficient resource allocation, and potential intellectual property (IP) leakage as more personnel are needed, including third parties. These issues are addressed in part by an enhanced control and flexibility grouping 504 and a team empowerment and expertise grouping 510 of the benefits diagram 500. The enhanced control and flexibility grouping 504 includes feature development that prioritizes and develops features based on immediate and future needs, customization that enables nimble modification and extension of the tool as needed without reliance on external or third party resources, and data ownership that provides full control over data to ensure compliance and security. The team empowerment and expertise grouping 510 includes skill development that enhances the technical expertise and problem-solving skills of the team.

The E2E observability system 200 allows for more secure and nimble development by making the development process more efficient. In the long run, this reduces the need for staff surging. The E2E observability system 200 allows for customization and enhancement to take place more efficiently. The E2E observability system 200 also allows companies to keep pace with organizational and market changes, consistent with the enhanced control and flexibility grouping 504, an advantage grouping 506, and a long-term cost efficiency grouping 508 of the benefits diagram 500. The advantage grouping 506 includes innovation that provides an ability to innovate faster and implement changes to better achieve and adapt to a dynamic environment and consumer needs, and unique capabilities that develop capabilities that better meet the specific needs of the business context and supported teams. The long-term cost efficiency grouping 508 includes a comparison of initial investment versus recurring costs, in which initial development investment of resources (e.g., time and cost) is recouped by long-term savings, and maintenance in which in-house maintenance provides for issue resolution and feature updates.

The example of FIG. 5 outlines key benefits of the benefits diagram 500. The key benefits include tailored solutions for specific needs represented by the tailored solutions for specific needs grouping 502, enhanced control and flexibility represented by the enhanced control and flexibility grouping 504, competitive advantage represented by the advantage grouping 506, long-term cost efficiency represented by the long-term cost efficiency grouping 508, and team empowerment and expertise represented by the team empowerment and expertise grouping 510.

FIG. 6 is a core features diagram 600 illustrating core features of the E2E observability system 200, according to some examples. Whereas FIGS. 1-5 describe the architecture, operational domains, proactive data management approach, purpose, and benefits of the E2E observability system 200, FIG. 6 describes the core features that the E2E observability system 200 provides. The core features diagram 600 is captioned “Build a Centralized Data Observability Solution” and is organized as a sequence of seven numbered steps, reflecting that creating a custom observability tool with centralized logging across the variety of tech stack across an enterprise allows for customization to meet evolving business requirements, and that this option provides control over features, scalability, and integration with existing systems.

Steps (1) and (2) of the core features diagram 600 address security and architecture. Step (1) is a security feature 602 that represents security with Role-Based Access Control (RBAC) and Single Sign-On (SSO) enabled user personas, and may further include Multi-Factor Authentication (MFA). Step (2) is an architecture feature 604 that represents an enterprise observability aligned architecture, aligns the E2E observability system 200 with the enterprise architecture, and supports multi-platform monitoring (e.g., pipelines, platforms, costs, cloud).

Steps (3) and (4) of the core features diagram 600 address the user-facing view and the underlying data store. Step (3) is a single pane of glass feature 606 that represents simplified navigation with fewer clicks. Unlike market products that focus on single aspects (e.g., Flexera for costs), the E2E observability system 200 integrates multiple capabilities and serves diverse organizational needs through the single pane of glass feature 606. Step (4) is a centralized log store feature 608 that represents centralized logging across data sources into an Elasticsearch (ES) repository and provides cross-platform insights.

Steps (5) and (6) of the core features diagram 600 address key performance indicators (KPIs) and insights. Step (5) is an end-to-end KPIs feature 610 that represents global, sector-specific, and program-specific KPIs across platforms, and the E2E observability system 200 provides trend analysis and job lineage via the end-to-end KPIs feature 610, features not found in conventional systems. Step (6) is an actionable insights feature 612 that represents operational, executive, and analytics insights provided at an E2E program, sector, or global level.

Step (7) of the core features diagram 600 is an alerts feature 614. The alerts feature 614 represents immediate KPI-driven alerts (trend based), through which the E2E observability system 200 delivers immediate notifications, and may be coordinated with root cause analysis (RCA) functions described elsewhere in this disclosure.

The example of FIG. 6 thus lists seven core features of the core features diagram 600 in order: security (RBAC and SSO) represented by the security feature 602, architecture alignment represented by the architecture feature 604, a single pane of glass interface represented by the single pane of glass feature 606, centralized log store represented by the centralized log store feature 608, end-to-end KPIs represented by the end-to-end KPIs feature 610, actionable insights represented by the actionable insights feature 612, and alerts represented by the alerts feature 614.

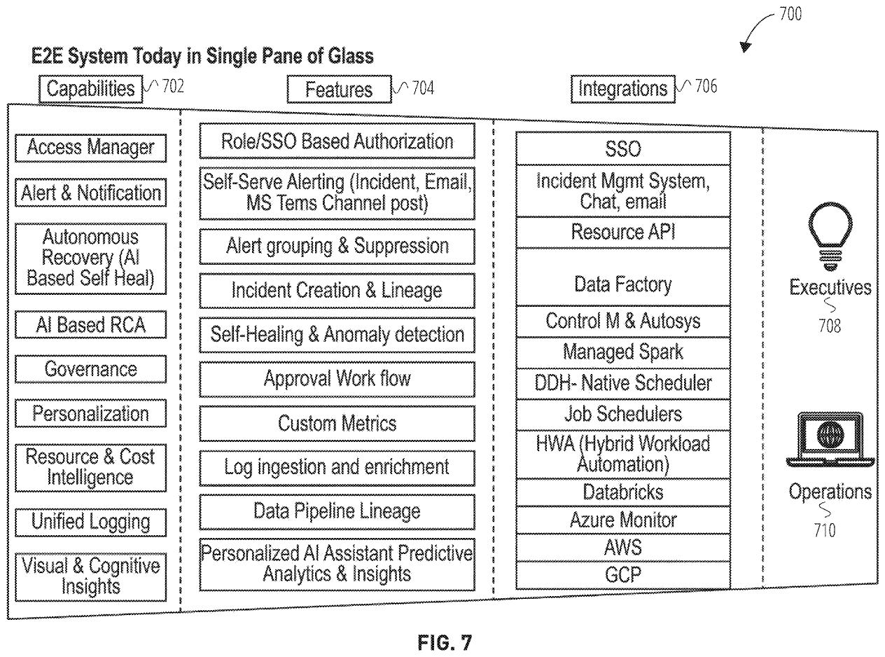

FIG. 7 is a single pane of glass diagram 700 illustrating the E2E observability system 200 as a single pane of glass, according to some examples. Continuing from the core features of FIG. 6, the single pane of glass diagram 700 presents how those core features are organized at the user-facing layer of the E2E observability system 200 as “E2E System Today in Single Pane of Glass.” The single pane of glass diagram 700 reiterates the single-pane-of-glass architecture, centralized log store, and actionable insights via dashboards and alerts (e.g., ticket creation, email, MS Teams, Slack, Zoom, or other messaging, texting, email, or communication applications). The single pane of glass diagram 700 also lists integrations (e.g., cloud-based service data integration, cloud-based service application programming interfaces (APIs)), with generic capabilities being generic. As shown in the example of FIG. 7, the E2E observability system 200 includes artificial intelligence (AI) self-healing capabilities. The single pane of glass diagram 700 is organized into a capabilities grouping 702, a features grouping 704, and an integrations grouping 706, and provides role-appropriate access for an executives persona 708 and an operations persona 710.

The capabilities grouping 702 of the single pane of glass diagram 700 lists capabilities of the E2E observability system 200 including an access manager, alert and notification, autonomous recovery (AI-based self heal), AI-based root cause analysis (RCA), governance, personalization, resource and cost intelligence, unified logging, and visual and cognitive insights. The features grouping 704 of the single pane of glass diagram 700 lists features corresponding to the capabilities grouping 702, including role/Single Sign-On (SSO)-based authorization, self-serve alerting (e.g., incident, email, MS Teams channel post, although other alerts are possible such as Slack, Zoom, or other communication and messaging applications), alert grouping and suppression, incident creation and lineage, self-healing and anomaly detection, approval work flow, custom metrics, log ingestion and enrichment, data pipeline lineage, and personalized AI assistant predictive analytics and insights. In example embodiments, the AI-based RCA capability of the capabilities grouping 702 is implemented by one or more AI agents that autonomously identify root causes of detected conditions by correlating events, traces, and metrics across the integrations grouping 706.

The integrations grouping 706 of the single pane of glass diagram 700 lists integrations that connect the capabilities grouping 702 and features grouping 704 to external systems, including SSO, an incident management system/chat/email, a cloud-based service Resource API, a cloud-based service Data Factory, workload automation tools used for job scheduling and process management (e.g., Control-M and Autosys), a managed big data processing service (e.g., managed Spark), a cloud-based job orchestration service with a native scheduler (DDH-Native Scheduler), and job schedulers. The integrations grouping 706 further includes a hybrid workload automation (HWA) tool, a unified analytics platform (e.g., Databricks, Microsoft Fabric, Azure Synapse Analytics, Snowflake, Amazon Redshift Serverless), a cloud-native monitoring service (e.g., Azure Monitor, Amazon CloudWatch, Google Cloud—Cloud Monitoring and Cloud Logging, Oracle Cloud—OCI Monitoring and Logging), and one or more cloud computing platforms including Amazon Web Services (AWS), IBM Cloud, and Google Cloud Platform (GCP). The capabilities grouping 702, the features grouping 704, and the integrations grouping 706 of the single pane of glass diagram 700 collectively serve the executives persona 708 (e.g., for high-level monitoring and strategic insights) and the operations persona 710 (e.g., for operational workflows, alert handling, and remediation).

FIG. 8 is a diagram illustrating a dashboard interface 800, according to some examples. As described with respect to FIG. 3, if there are any data delays or pipeline failures in any of the hops, the E2E observability system 200 is configured to proactively send alerts to notify the business of the issue. By way of non-limiting example, the dashboard interface 800 may notify with respect to one or more of a P3 incident, an MS Teams channel post/notification, and an email summary of critical jobs. For example, the E2E observability system 200 provides for end-to-end pipeline monitoring for a North American (NA) supply chain business. The dashboard interface 800 includes a header section 802, a current status section 804, a platform status section 806, a historic trend section 808, and a data reconciliation and validation framework section 810, arranged vertically in the drawing.

The header section 802 identifies the dashboard as a “Scheduler Health” view titled “Sector Executive Dashboard” for “Sector Specific Supply Chain,” and displays a last-refreshed timestamp (e.g., “Last Refreshed: Mon, 21 Apr. 2025, 02:19 AM”).

The current status section 804 shows Service Level Agreement (SLA) metrics and actual completion times compared against SLA target times for various processes. The current status section 804 includes a legend indicating three SLA outcome states: “SLA Met,” “SLA To Be Determined,” and “SLA Missed.” The current status section 804 is presented via a BusinessObjects Data Services (BODS) current status element 812, a master data transfer (MDT) current status element 814, a global enterprise data warehouse (GEDW) current status element 816, and a sector-specific enterprise data warehouse (EDW) current status element 818. By way of non-limiting example, the BODS current status element 812 shows an SLA time of 03:00 AM Central Standard Time (CST) and an actual completion time of 11:30 PM CST; the MDT current status element 814 shows a completion timestamp of Mon, 21 Apr. 2025, 02:29 AM; the GEDW current status element 816 shows an SLA time of 06:30 AM CST and an actual completion time of 05:00 AM CST; and the sector-specific EDW current status element 818 shows an SLA time of 08:00 AM CST and an actual completion time of 06:50 AM CST.

The platform status section 806 presents platform-specific metrics as of a given date (e.g., 04/21/2025) and is arranged with a total jobs row 820, a SLA status row 822, and a platform health row 824, each populated across a BODS column 826, an MDT column 828, a GEDW column 830, and a sector-specific EDW column 832. Total job counts per platform are shown in the total jobs row 820 (e.g., 34 jobs for BODS, 57 jobs for MDT, 9 jobs for GEDW, and 2 jobs for sector-specific EDW). SLA status indicators are shown in the SLA status row 822 (e.g., “SLA Met” for one or more platforms, and “COMING SOON” where SLA reporting is not yet enabled). Platform health status indicators are shown in the platform health row 824 (e.g., “SLA Met” for one or more platforms, and “COMING SOON” where platform health reporting is not yet enabled).

The historic trend section 808 provides SLA performance tracking over multiple time periods via a SLA type row 834, a last 7 days row 836, a last 14 days row 838, and a last 30 days row 840, each populated across a BODS column 842, an MDT column 844, a GEDW column 846, and a sector-specific EDW column 848. The SLA type row 834 identifies a per-platform SLA outcome pairing (e.g., “SLA Met|SLA Missed”) that is counted in the rows below. By way of non-limiting example, the last 7 days row 836 may show counts such as “7|0” (i.e., 7 SLA Met and 0 SLA Missed); the last 14 days row 838 may show counts such as “14|0” (e.g., for the sector-specific EDW) or “7|0” (for other platforms); and the last 30 days row 840 may show counts such as “28|2” across one or more of the platforms.

The data reconciliation and validation framework section 810 presents a validation framework for assessing data integrity from source to target across the data pipeline. The data reconciliation and validation framework section 810 includes a plurality of reconciliation techniques arranged as rows and evaluated across a plurality of platforms arranged as columns. The reconciliation techniques include a record count row 850 (e.g., comparison of source and target record counts); a field-level reconciliation row 852 (e.g., source-to-target comparison of data values at a column or field level); an aggregation validation row 854 (e.g., checksums, and sum, minimum, or maximum comparisons across source and target datasets); a data quality rules row 856 (e.g., null checks, range checks, referential integrity checks, and format validations); a duplicate detection row 858 (e.g., identification of duplicate primary keys or duplicate records at source or target); a pushdown validation row 860 executed at the data source to reduce data movement and leverage native source processing; a custom rules row 862 enabling program-specific or sector-specific validation rules to be defined and executed within the validation framework; and a reconciliation status row 864 derived from the outcomes of the foregoing reconciliation techniques 850-862 and indicating a balanced, unbalanced, or warning state. The platforms include a BODS column 866, an MDT column 868, a GEDW column 870, and a sector-specific EDW column 872. Each cell defined by the intersection of a reconciliation technique row 850-864 and a platform column 866-872 presents an outcome of the corresponding reconciliation technique for the corresponding platform. By presenting source-to-target reconciliation across record-count, field-level, aggregation, data-quality, duplicate, pushdown, and custom-rule dimensions, the E2E observability system 200 validates data completeness and data integrity across the data pipeline and surfaces data loss, data duplication, data-quality degradation, and transformation-logic errors that may not be detected by pipeline-level telemetry alone.

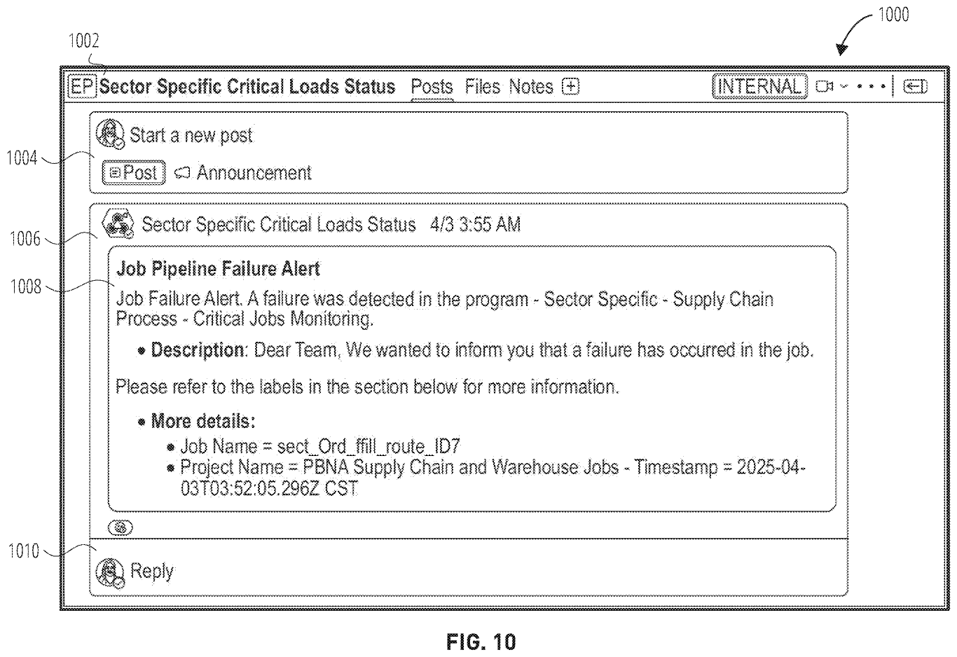

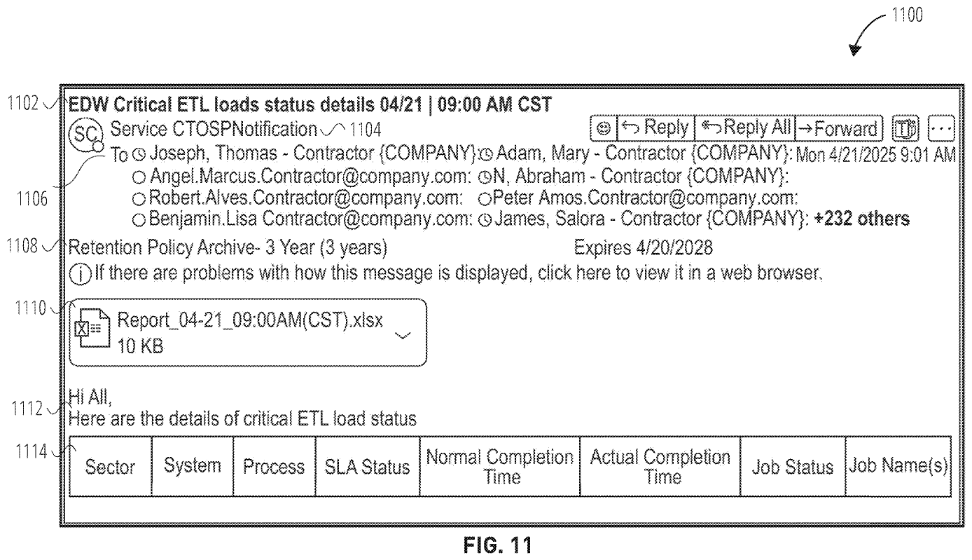

In example embodiments, the dashboard interface 800 illustrates how the E2E observability system 200 provides single pane of glass visibility for executives and operations teams, with simplified navigation and fewer clicks to access information. The dashboard interface 800 further illustrates the capability of the E2E observability system 200 to provide actionable insights and end-to-end key performance indicators (KPIs) across different platforms and programs through the combination of the header section 802, the current status section 804, the platform status section 806, the historic trend section 808, and the data reconciliation and validation framework section 810. The dashboard interface 800 may additionally be used in conjunction with email summaries of critical extract, transform, load (ETL) jobs, as described with respect to FIG. 10 and FIG. 11.

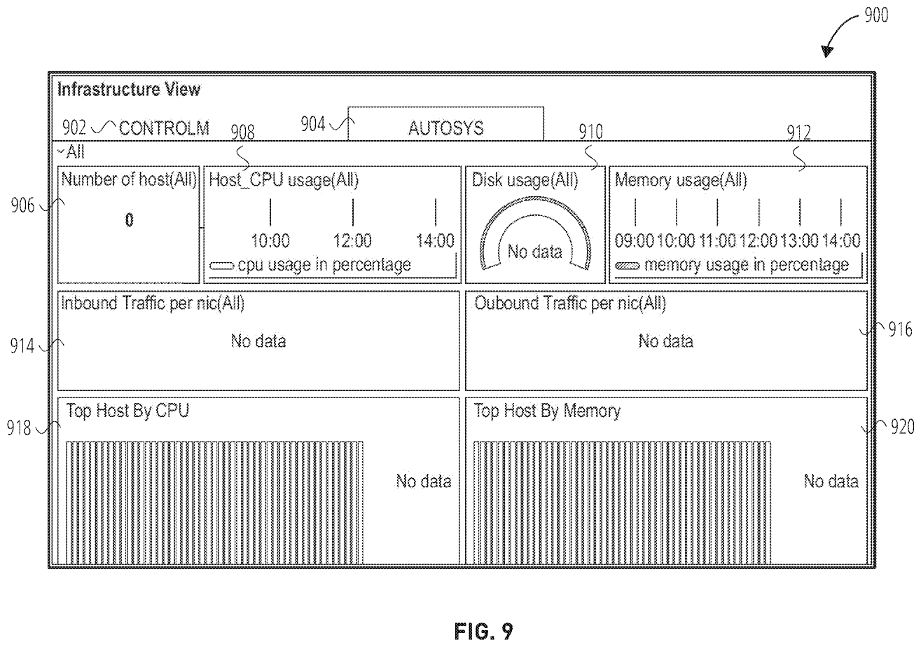

FIG. 9 is a diagram illustrating an infrastructure view user interface 900 related to an infrastructure view, according to some examples. Continuing from the dashboard interface 800 of FIG. 8, which surfaces scheduler and SLA-level information, the infrastructure view user interface 900 surfaces infrastructure-level performance metrics for the underlying hosts on which those schedulers operate. As shown in the example of FIG. 9, the infrastructure view user interface 900 is titled “Infrastructure View” and displays system performance metrics for a selected scheduler system. The infrastructure view user interface 900 includes a Control-M section 902 and an Autosys section 904, which represent selectable tabs for monitoring the CONTROLM and AUTOSYS scheduler systems, respectively. A filter control (labeled “All”) enables the displayed metrics to be scoped across all monitored hosts.

The infrastructure view user interface 900 includes multiple performance graphs and metrics panels for infrastructure components, including a number-of-hosts panel 906, a host central processing unit (CPU) usage panel 908, a disk usage panel 910, a memory usage panel 912, an inbound-traffic-per-network-interface-card-(NIC) panel 914, an outbound-traffic-per-NIC panel 916, a top host by CPU panel 918, and a top host by memory panel 920. The number-of-hosts panel 906 (labeled “Number of host(All)”) indicates the quantity of hosts being monitored at a given time (e.g., 0 in the illustrated example). The host CPU usage panel 908 (labeled “Host_CPU usage(All)”) displays CPU usage over time with a y-axis labeled “cpu usage in percentage” and an x-axis showing timeline values (e.g., 09:00, 10:00, 11:00, 12:00, 13:00, 14:00). The disk usage panel 910 (labeled “Disk usage(All)”) displays disk usage metrics. The memory usage panel 912 (labeled “Memory usage(All)”) displays memory usage over time with a y-axis labeled “memory usage in percentage” and an x-axis showing timeline values (e.g., 09:00, 10:00, 11:00, 12:00, 13:00, 14:00).

The infrastructure view user interface 900 further includes network traffic panels, including the inbound-traffic-per-NIC panel 914 (labeled “Inbound Traffic per nic(All)”) and the outbound-traffic-per-NIC panel 916 (labeled “Outbound Traffic per nic(All)”), each of which displays per-NIC traffic metrics. The infrastructure view user interface 900 additionally includes the top host by CPU panel 918 (labeled “Top Host By CPU”) and the top host by memory panel 920 (labeled “Top Host By Memory”), each of which identifies the hosts ranked highest by the corresponding metric. One or more of the disk usage panel 910, the inbound-traffic-per-NIC panel 914, the outbound-traffic-per-NIC panel 916, the top host by CPU panel 918, and the top host by memory panel 920 may display a “No data” indicator where no corresponding metric data is available for the displayed timeframe.

The infrastructure view user interface 900 is configured to monitor both CONTROLM and AUTOSYS scheduler systems, represented respectively by the Control-M section 902 and the Autosys section 904. The Control-M section 902 and the Autosys section 904 each surface corresponding metrics via the number-of-hosts panel 906, host CPU usage panel 908, disk usage panel 910, memory usage panel 912, inbound-traffic-per-NIC panel 914, outbound-traffic-per-NIC panel 916, top host by CPU panel 918, and top host by memory panel 920. This arrangement aligns with the platform health monitoring and integrated full stack observability capabilities of the E2E observability system 200 described with respect to FIG. 2.

In the example of FIG. 9, the infrastructure view user interface 900 shows timeline-based graphs with measurement periods from approximately 09:00 to 14:00, with some panels indicating “No data” for certain metrics during the displayed timeframe. Such timeline-based graphs may be rendered within any of the host CPU usage panel 908, disk usage panel 910, memory usage panel 912, inbound-traffic-per-NIC panel 914, outbound-traffic-per-NIC panel 916, top host by CPU panel 918, or top host by memory panel 920.

Thus, the infrastructure view user interface 900 illustrates how the E2E observability system 200 provides for one or more of: integration with heterogeneous systems (e.g., monitoring across multiple scheduler platforms (CONTROLM and AUTOSYS) via the Control-M section 902 and the Autosys section 904 in a unified view); contextual data enrichment; integrated business context; AI-driven insights; multi-persona views; a unified telemetry store; and custom alerting channels.

FIG. 10 is a diagram illustrating a notifications user interface 1000 related to alerting and notifications, according to some examples. Continuing from the infrastructure view user interface 900 of FIG. 9, which surfaces platform-and infrastructure-level metrics, the notifications user interface 1000 surfaces the downstream notifications produced by the E2E observability system 200 when a condition of interest is detected. As shown in the example of FIG. 10, the notifications user interface 1000 illustrates alerting functionality implemented through multiple notification channels and is rendered within a collaboration application (e.g., Microsoft Teams (MS Teams), Slack, Zoom, or other communication and messaging applications).

The notifications user interface 1000 includes a channel header 1002, a new post element 1004, a post panel 1006, post details 1008, and a reply element 1010, arranged vertically in the drawing. The channel header 1002 identifies the communication channel (e.g., labeled “Sector Specific Critical Loads Status”) and includes navigation tabs for “Posts,” “Files,” and “Notes,” along with an add-tab control (“+”). The channel header 1002 further includes a channel designation (e.g., “EP” for an enterprise posts channel or similar channel/workspace designation) and a classification indicator (e.g., “INTERNAL”) identifying the audience or sensitivity of the channel. The new post element 1004 provides a post-composition control (e.g., labeled “Start a new post”) through which posts may be initiated, and includes toolbar options for post types including a standard “Post” and an “Announcement.”

The post panel 1006 presents alert content generated by the E2E observability system 200. In the illustrated example, the post panel 1006 displays a post title corresponding to the channel (e.g., “Sector Specific Critical Loads Status”) along with a post timestamp (e.g., “4/3 3:55 AM”). Within the post panel 1006, post details 1008 are presented, including an alert heading (e.g., “Job Pipeline Failure Alert”), a summary sentence indicating a detected failure (e.g., “Job Failure Alert. A failure was detected in the program—Sector Specific—Supply Chain Process—Critical Jobs Monitoring.”), a description field (e.g., prefixed “Description:” and stating “Dear Team, We wanted to inform you that a failure has occurred in the job. Please refer to the labels in the section below for more information.”), and a “More details:” section containing one or more labeled fields identifying the failed job. By way of non-limiting example, the labeled fields include a Job Name (e.g., “sect_Ord_ffill_route_ID7”), a Project Name (e.g., “PBNA Supply Chain and Warehouse Jobs”), and a Timestamp (e.g., “2025-04-03T03: 52:05.296Z Central Standard Time (CST)”).

The reply element 1010 (e.g., labeled “Reply”) enables responses to the alert content presented in the post panel 1006 and supports user engagement and follow-up actions. The notification channels accessible through the notifications user interface 1000 include, by way of non-limiting example: an MS Teams channel post surfaced via the post panel 1006 and the post details 1008 (with other collaboration applications, such as Slack or Zoom, also possible); an email notification sent to multiple stakeholders or contractors that includes an attached spreadsheet report (e.g., discussed further with respect to FIG. 11); and structured fields for reporting load status. The channel header 1002 provides context for the alert content presented in the post panel 1006, and the reply element 1010 supports user engagement and follow-up actions.

In example embodiments, the notifications user interface 1000 illustrates how the E2E observability system 200 provides for delivering notifications through multiple channels (e.g., email, chat) based on user preferences and supports automated incident management. For example, the alerts presented via the post panel 1006 and the post details 1008 demonstrate the capability of the E2E observability system 200 to provide immediate key performance indicator (KPI)-driven alerts with detailed contextual information for different user personas, while the new post element 1004 and the reply element 1010 enable interactive engagement with the alerts.

FIG. 11 is a diagram illustrating an email message 1100, according to some examples. Continuing from the notifications user interface 1000 of FIG. 10, which surfaces a chat-channel post notification generated by the E2E observability system 200, the email message 1100 illustrates an email notification generated by the E2E observability system 200 for the same category of detected condition. The email message 1100 provides details for a critical extract, transform, load (ETL) loads status for an enterprise data warehouse (EDW).

The email message 1100 includes a subject line 1102, a sender 1104, a recipient list 1106, a retention policy indicator 1108, attachment(s) 1110, a message body 1112, and a status table 1114, arranged vertically in the drawing.

The subject line 1102 identifies the subject matter of the email message 1100 (e.g., labeled “EDW Critical ETL loads status details 04/21 |09:00 AM Central Standard Time (CST)”). The sender 1104 identifies the originator of the email message 1100 (e.g., labeled “Service CTOSPNotification”) and a send timestamp (e.g., “Mon Apr. 21, 2025 9:01 AM”). The email message 1100 further includes email-client controls (e.g., labeled “Reply,” “Reply All,” and “Forward”) enabling user engagement with the email message 1100.

The recipient list 1106 identifies multiple recipients to whom the email message 1100 was sent, including, by way of non-limiting example, individually named contractors or team members (e.g., “Joseph, Thomas—Contractor (COMPANY),” “Adam, Mary-Contractor (COMPANY),” “N. Abraham—Contractor (COMPANY)”), recipients identified by email address (e.g., “Angel.Marcus.Contractor@company.com,”“Peter.Amos.Contractor@company. com,”“Robert.Aves.Contractor@company.com,”“Benjamin.Lisa.Contractor@company.com”), and an aggregate recipient indicator (e.g., “+232 others”) representing additional recipients.

The retention policy indicator 1108 identifies a retention policy applied to the email message 1100 (e.g., labeled “Retention Policy Archive—3 Year (3 years)”) and an associated expiration date (e.g., “Expires 4/20/2028”). The email message 1100 further includes an in-message notice (e.g., “If there are problems with how this message is displayed, click here to view it in a web browser.”) providing an alternative rendering option for the email message 1100.

The attachment(s) 1110 represents one or more files appended to the email message 1100. By way of non-limiting example, the attachment(s) 1110 includes a spreadsheet report (e.g., labeled “Report_04-21_09:00AM(CST).xlsx,” with a displayed file size of approximately 10 kilobytes (KB)) containing detailed load status information.

The message body 1112 contains a salutation and a lead-in to the load status information (e.g., “Hi All,” followed by “Here are the details of critical ETL load status”). The status table 1114 provides a structured presentation of load status information and, by way of non-limiting example, includes columns labeled “Sector,” “System,” “Process,” “SLA Status,” “Normal Completion Time,” “Actual Completion Time,” “Job Status,” and “Job Name(s).” The message body 1112 and the status table 1114 together contain structured fields for reporting load status.

In example embodiments, the email message 1100 illustrates how the E2E observability system 200 provides a configurable alerting engine that enables automated incident management and customized notifications based on user preferences. The email message 1100 further illustrates the capability of the E2E observability system 200 to provide immediate key performance indicator (KPI)-driven alerts with detailed contextual information across different platforms and programs, via the subject line 1102, sender 1104, recipient list 1106, retention policy indicator 1108, attachment(s) 1110, message body 1112, and status table 1114.

FIGS. 12A and 12B comprise a block diagram (split in two for readability) showing an example networked computing environment 1200 for facilitating a manufacturing process in a manufacturing environment. As noted above, a manufacturing system may correspond to one of multiple data sources from which the E2E observability system 200 draws heterogeneous data.

FIG. 12A is a part of the block diagram showing a manufacturing system 1202 of the networked computing environment 1200 and FIG. 12B is a part of the block diagram showing a cloud computing system 1204 of the networked computing environment 1200. Each component in the networked computing environment 1200 is communicatively connected via one or more communication networks to exchange data and messages.

The manufacturing system 1202 shown in FIG. 12A can be a computing system located in a manufacturing warehouse or other manufacturing environment and comprises a number of assets 1206. These assets 1206 can include one or more devices, such as one or more cameras 1208, a weigher 1210, a bag maker 1212, a robotic arm, or other assets 1206. It is to be understood that any given manufacturing system 1202 can include more, less, or different assets than what is shown in FIG. 12A. As mentioned above, each of these assets comprises numerous sensors.

In addition to the example sensors mentioned above, example sensors can include sensors from cameras in an entrance or parking lot of the manufacturing environment to track vehicles coming in and out and ensure authorized vehicles are on schedule. Example sensors can further include sensors on a warehouse or factory floor to detect whether employees are wearing personal protective equipment and location of employees to ensure safety, to ensure no unauthorized access, to protect trade secrets and other intellectual property, and to ensure employees not working too many consecutive hours, among other things. Other examples include sensors to monitor, log, and optimize forklift traffic to make sure operators are not driving too fast and issue any warning as needed. Other sensors can include those in a bottling line, which measure, among other things, conveyor speed, bottling rate, flow rate for the product/beverage, sterilant, water, air, and any other fluid in the system, temperature of food product, sterilant, sanitizer, water, air, or any other relevant component of the system, pressure, air quality, proximity, and processing parameters. For example, drops in pressure could indicate, among other things, insufficient sterilant or sanitizer flow, the absence of air flow (underpressure or overpressure) necessary to separate different zones (e.g., beverage filling from bottle capping or bottle sterilizing) from each other. In the case of beverages, this is important because, for example, sanitizer or sterilant should not be in the food products for a number of reasons, including, but not limited to, consumer health and satisfaction, industry standards, and relevant government agency standards. Other sensors can include the snack food processing machine equivalents of the sensors associated with the bottling line. Bottling lines and their facilities can have: conveyors that feed bottles or preforms into the machine; conveyors, grippers, rotary lines and the like that transport the bottes from one zone/area of the bottling machine to another; bottle cleaning, sanitization, and/or sterilization area, bottle drying area, bottle filling zones, bottle capping zones, and output areas where the capped bottle containing a beverage is palletized, prepared for shipping, stacked/stored in a warehouse, and loading and unloading docks. Each one of these components has sensor data associated with it and is managed/facilitated by the system described herein. This can also include sensors that monitor cooking temperature, moisture of the chips, humidity, air quality, acoustic data to sense texture, vibration, temperatures across various zones of the machine or plant. Chip and snack processing machines can include the following zones, areas, and/or components: sorting and grading machines; washing; peeling; cutting; blanching; dewatering; cooking; deoiling; drying; and packaging.

Industrial, agricultural, and CPG companies often utilize the following types of sensors to collect relevant critical data, such as but not limited to: (1) temperature sensors (e.g., monitor to ensure optimal processing and storage parameters; prevents product damage or degradation; used in gas and fluid flow (where fluid can include food product, beverage, sanitizer, cleanser, sterilant, air, steam, and water), and HVAC; can be used to reduce energy consumption and to reduce environmental impact; can be used to make sure snacks are properly cooked by monitoring, inter alia, cooking temperature and product temperature); (2) motion sensors (e.g., monitor motion in bottling machines, food processing machines, plants, warehouse facilities, and adjoining or surrounding areas; this can include monitoring activity in a plant to determine, among other things, the amount of people present and ensure maximum occupancy limits aren't exceeded, modify utility activation like turning off lights in unpopulated areas; can be placed in machinery in areas/zones where motion corresponds to activity); (3) environmental sensors (e.g., can monitor humidity/moisture level in the air which can be relevant for a number of use cases including agricultural and making sure warehouses or machinery are at appropriate levels); (4) rain sensors (can be used to detect rainfall in agricultural environments like farms where potatoes and other fruits or vegetables are grown); (5) gas sensors (e.g., can detect the composition or the presence of gases, which can be used to optimize food processing, ensure food safety, monitor plant safety conditions, and ensure compliance with relevant regulations; air quality); (6) soil humidity sensors (e.g., generates, inter alia, soil moisture data that can be used to make sure watering and irrigation is sufficient; can be used optimize agricultural yield); (7) pressure sensors (e.g., monitor proper fluid flow); (8) water and fluid sensors (e.g., monitor pH; monitor clarity of fluid); (9) tank level sensors (e.g., can be in sterilant, sanitizer, water, beverage, food product, and other tanks; can be used to monitor for presence of gas or fluid, or make sure there is not a danger posed by a leak); (10) GPS sensors (e.g., logistics; tracking and monitory resources and shipments); (12) proximity sensors (e.g., make sure collisions are avoided in production plant and warehouses; make sure beverage, snack, and food processing machines are operating correctly by, e.g., making sure bottles don't bump into each other and fall over, making sure machinery components are moving, interacting, and operating correctly; ensure obstacles are removed, whether in machinery or in warehouse floor); (12) optical sensors (e.g., include cameras and video; monitor lighting to ensure it matches with legal requirement; monitor/display/inspect food, beverage, or snack products; can be used to count items including individual chips, bottles, etc.); (13) thermal cameras (e.g., ensure food products or other items are at proper/optimal temperature); (14) vibration sensors (e.g., vibration rates can be used to judge machine health and make sure machines are operating properly; anomalous readings can trigger modifications that extend the life/health of relevant machinery).

The manufacturing system 1202 can further include one or more graphical user interfaces, such as a human machine interface (HMI) 1216, that can be used by users 1218 such as plant operators or other users to monitor and control the assets 1206 and other devices in the manufacturing system 1202.

The manufacturing system 1202 comprises a programmable logic controller (PLC) data concentrator 1220 that manages the assets 1206 and other devices, an open platform communications unified architecture (OPC UA) server 1222 that is a machine-to-machine communication protocol, and a gSFT API 1224 that is able to cause display of an event or other data on an HMI 1216 that has access to a manufacturing execution (MES) system 1226. In one embodiment, the interactive interface allows for: (1) real-time and historical analysis of the data and KPIs discussed herein; (2) real-time interactivity to modify processes; and (3) the subsequent improvement of goods created by a company. For example, this interactive interface can allow a user to, among other things: (1) stop production if sterilization temperatures are insufficient; (2) reroute a shipment based on updated traffic patterns; (3) accurately and safely increase production speed if demand for a particular plant increases; and/or (4) modify staffing or reduce pricing based on relevant data.

The manufacturing system 1202 further comprises a universal system 1228 that comprises various components such as those shown in FIG. 12A. The universal system 1228 can provide server-side functionality via a network to these various components and to the cloud computing system 1204. The universal system 1228 provides various services and operations that are provided to various components within the manufacturing system 1202 and to the cloud computing system 1204. Such operations include transmitting data to, receiving data from, and processing data generated by one or more assets 1206, the cloud computing system 1204 or other components within the manufacturing system 1202. This data can include sensor data, images, video, messages, and other data.

The universal system 1228 comprises a Publication and Subscription (Pub/Sub) component 1230 for publishing data and subscribing to events and data. The Pub/Sub component 1230 maintains the order of events so that they stay in the correct chronological order. Along with the chronological order, the Pub/Sub component 1230 also allows multiple consumers or applications consume the same data which is published once and subscribed multiple times to save the compute. For example, a message (e.g., alert) can be simultaneously sent to the HMI 1216 for an operator visibility, the OPC UA server 1222 to actuate a sensor, a digital twin to maintain the state, and via text or email to alert the operator or supervisor.

The universal system 1228 further comprises a factory floor integration engine 1232 for receiving data from the assets 1206 and other devices and an asset auto discovery component 1234 for scanning the assets 1206 to determine any new assets 1206 or new sensors that have been added to the manufacturing system 1202. This auto discovery makes the universal system 1228 more adaptable across all platforms and enables data that can be universally annotated to be used across an enterprise.

The universal system 1228 further comprises a custom application system 1236 that comprises an analytics service 1238 and an anomaly detection service 1240. The custom application system 1236 can include various applications, machine learning models, or other tools for analyzing data, via the analytics service 1238, that is received from the assets 1206 and other devices in the manufacturing system 1202 to detect if any data triggers any rules or anomalies, via the anomaly detection service 1240, for which an alert needs to be generated. The applications, machines learning models, or other tools can be provided for various technical and business use cases in the manufacturing system 1202 via the custom application system 1236. The universal system 1228 can interface with any application.

The universal system 1228 further comprises a data streaming service component 1242 and a mounted persistent volume claim (PVC) store 1244 to send data to the cloud computing system 1204 and a lightweight data processing component 1246 for aggregation and pruning of data.

The universal system 1228 also comprises API management 1248, continuous integration and continuous delivery or deployment (CI/CD) 1250 to continuously deliver machine learning models to the universal system 1228, and high availability 1252 that can replicate data, workloads, and/or models that are business critical across different nodes to ensure the data is available across different nodes regardless of whether one or more nodes becomes disabled.

The universal system 1228 further comprises a containerization stack 1254 and an operating system 1256, such as MacOS, Windows, Unix, Linux or another operating system.

The assets 1206, such as the operational technology (OT) devices, can continuously, in real-time, send data (e.g., sensor data) to the PLC data concentrator 1220 which sends the data to the factory floor integration engine 1232. The cameras 1208 can also each send data as a camera stream, continuously, in real-time, to the factory floor integration engine 1232. For instance, data from field sensors and devices (e.g., assets 1206) are transmitted to the factory floor integration engine 1232 of the universal system 1228 through PLC data concentrator 1220 and OPC UA server 1222. As per the ISA 95 standards, the pattern can be to extract data from the OPC UA server 1222 rather than integrating with the PLC data concentrator 1220 directly. A camera stream (e.g., RTSP stream data) from each of one or more cameras 1208 can be directly ingested by the factory floor integration engine 1232. The universal system 1228 has the capability to fetch data that is available in various systems, including, but not limited to, the OPC UA server 1222, historians, MES, SQL, IoT sensors and gateways, and the like, using different protocols such as MODBUS, PROFINET, and so forth.

The OT data from the factory floor integration engine 1232 can be transmitted to the analytics service 1238 of a custom solution in the custom application system 1236, with the help of the lightweight messaging infrastructure available on the universal system 1228. Preprocessing is enabled in the universal system 1228 to eliminate bad data and contextualize data that is required for the analytics service 1238. For example, images captured by a camera 1208 are tagged with information captured from the MES system 1226 or OPC UA server 1222. During preprocessing the universal system 1228 can further determine actuation decisions which are then passed to the factory floor integration engine 1232 via the Pub/Sub component 1230 messaging service. The actuation decision is transmitted through the factory floor integration engine 1232 to the OPC UA server 1222 and then to the PLC data concentrator 1220 which commands the corresponding actuator. The analytics service 1238 of the custom application system 1236 can also decide to stream the data or send the data in batch format for machine learning model retraining, as explained in further detail below. The streaming data can be transmitted to the streaming component 1258 of the cloud computing system 1204 or to any third-party platform, including a third-party application/SAAS 1288.

The analytics service 1238 can transmit any events via the API management 1248 to the MES system 1226. The analytics service 1238 can transmit data to the anomaly detection service 1240 to determine the health and success ratio of one or more machine learning models running on the universal system 1228. The anomaly detection service 1240 can transmit data to the mounted PVC store 1244 for retraining which is in turn transmitted to the cloud computing system 1204. This data (such as images) can be first be compressed via a compression function so that the network bandwidth can be optimized. In some examples, the data can be optimized in size and include only the necessary amount required for retraining to improve the analytics model or service.

The manufacturing system 1202 via the universal system 1228 can communicate with the cloud computing system 1204 shown in FIG. 12B. The cloud computing system 1204 comprises various components such as the internet of things (IoT) processing and routing component 1260 that can stream data to applications and third-party applications 1262 via business logic 1264, to notification service 1266 for alerts via SMS, email, or other method, and to time series data storage 1268. Alarms and events can also be sent via the data streaming component 1242 to the messaging component 1270. The cloud computing system 1204 further comprises a container orchestration component 1272 and a container registry component 1274 as well as data storage 1276 and consume 1278 and analyze 1280 components.

The cloud computing system 1204 further comprises integration via an API hosting 1282 and API management component 1284. The cloud computing system 1204 can include one or more custom application 1262 comprising business logic 1264 and data access 1286 and one or more third-party application/SAAS 1288. The cloud computing system 1204 can be accessed by users such as data engineers 1290, for example, through one or more user interfaces on one or more computing devices.

In the event of loss of connectivity to the cloud computing system 1204, the universal system 1228 can store data locally for a set duration for each application depending on criticality and resume forwarding the data as soon as the connectivity is back online. The universal system 1228 can also scale up application workloads based on need. For example, if excess data is being processed from the sensors and the application workloads need additional compute to process the data spike, more compute resources can be allocated in order to process and make a decision in real time or near real time.

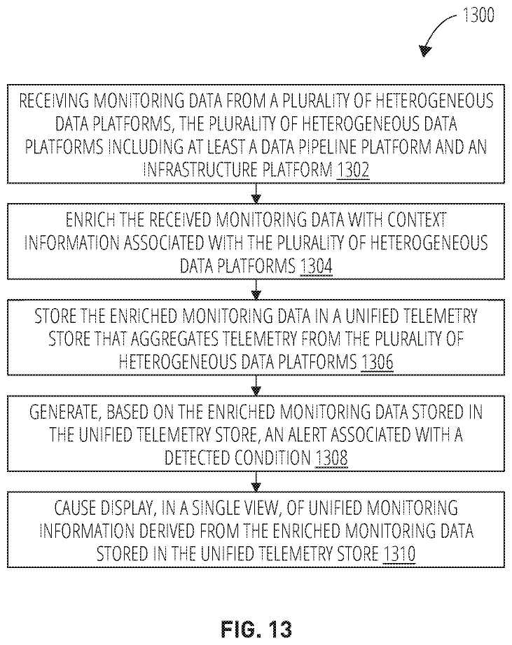

FIG. 13 is a flowchart illustrating a process 1300 for end-to-end observability across heterogeneous data platforms, in accordance with some examples. For explanatory purposes, the process 1300 is primarily described herein with reference to the E2E observability system 100 of FIG. 1. However, one or more blocks (or operations) of the process 1300 may be performed by one or more other components, and/or by other suitable devices. Further for explanatory purposes, the blocks (or operations) of the process 1300 are described herein as occurring in serial, or linearly. However, multiple blocks (or operations) of the process 1300 may occur in parallel or concurrently. In addition, the blocks (or operations) of the process 1300 need not be performed in the order shown and/or one or more blocks (or operations) of the process 1300 need not be performed and/or can be replaced by other operations. The process 1300 may be terminated when its operations are completed. In addition, the process 1300 may correspond to a method, a procedure, an algorithm, etc.

At block 1302, the E2E observability system 100 receives monitoring data from a plurality of heterogeneous data platforms, the plurality of heterogeneous data platforms including at least a data pipeline platform and an infrastructure platform. In example embodiments, the monitoring data comprises real-time monitoring data and batch monitoring data.

The E2E observability system 100 enriches the received monitoring data with context information associated with the plurality of heterogeneous data platforms (block 1304). In example embodiments, the context information comprises program-specific context information.

The E2E observability system 100 stores the enriched monitoring data in a unified telemetry store that aggregates telemetry from the plurality of heterogeneous data platforms (block 1306).

In example embodiments, the E2E observability system 100 generates, based on the enriched monitoring data stored in the unified telemetry store, an alert associated with a detected condition (block 1308). In example embodiments, the alert is generated based on one or more configurable rules applied to the enriched monitoring data. The E2E observability system 100 detects a violation of a service level agreement based on the one or more configurable rules. The E2E observability system 100 automatically generates an incident ticket based on the detected violation.

In example embodiments, the E2E observability system 100 transmits notifications associated with the alert through a plurality of configurable channels, the plurality of configurable channels including email notifications and chat notifications.

In example embodiments, the E2E observability system 100 causes display, in a single view, of unified monitoring information derived from the enriched monitoring data stored in the unified telemetry store (block 1310).

In example embodiments, the E2E observability system 100 filters the unified monitoring information based on a user role. The user role comprises one of an executive persona and an operations persona, and wherein the single view differs based on the user role.

In example embodiments, the E2E observability system 100 tracks data lineage of the monitoring data across multiple hops within the plurality of heterogeneous data platforms. The E2E observability system 100 identifies a source of the detected condition based on the tracked data lineage.

In example embodiments, the E2E observability system 100 executes an automated self-healing action to remediate the detected condition. The automated self-healing action comprises scaling up application workloads by allocating additional compute resources.

### MACHINE ARCHITECTURE

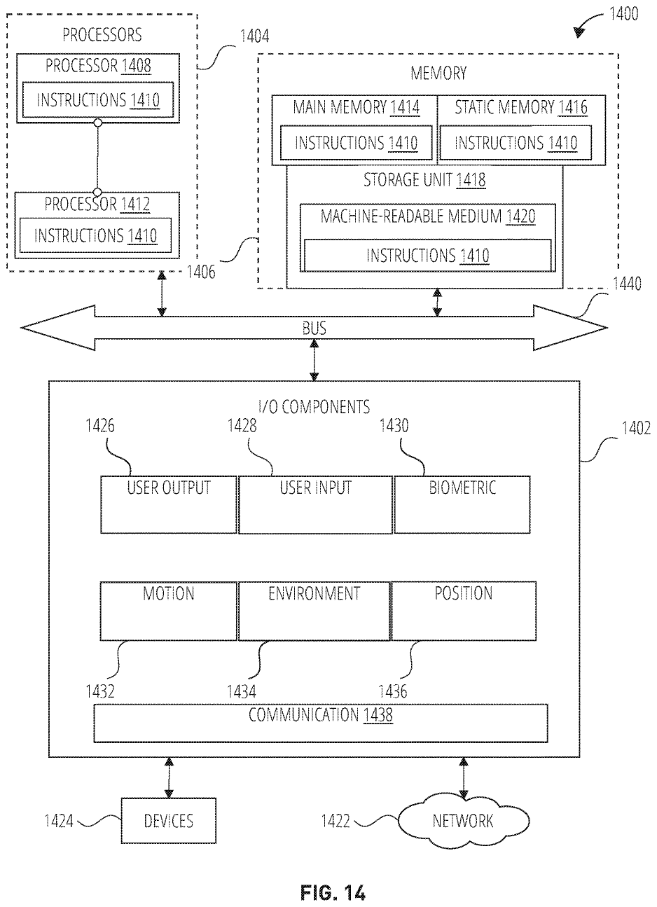

In some examples, components in the E2E observability system 100 or 200 can be a machine 1400 as shown in FIG. 14. FIG. 14 is a diagrammatic representation of the machine 1400 within which instructions 1410 (e.g., software, a program, an application, an applet, an application, or other executable code) for causing the machine 1400 to perform any one or more of the methodologies discussed herein may be executed. For example, the instructions 1410 may cause the machine 1400 to execute any one or more of the methods described herein. The instructions 1410 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1410, sequentially or otherwise, that specify actions to be taken by the machine 1400. Further, while only a single machine 1400 is illustrated, the term “machine” shall also be taken to include a collection of machines that individually or jointly execute the instructions 1410 to perform any one or more of the methodologies discussed herein. The machine 1400, for example, may comprise any one of a number of client and/or server devices forming part of the E2E observability system 200. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1402, which may be configured to communicate with each other via a bus 1440. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1408 and a processor 1412 that execute the instructions 1410. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1414, a static memory 1416, and a storage unit 1418, both accessible to the processors 1404 via the bus 1440. The main memory 1414, the static memory 1416, and storage unit 1418 store the instructions 1410 embodying any one or more of the methodologies or functions described herein. The instructions 1410 may also reside, completely or partially, within the main memory 1414, within the static memory 1416, within machine-readable medium 1420 within the storage unit 1418, within at least one of the processors 1404 (e.g., within the processor's cache memory), or any suitable combination thereof, during execution thereof by the machine 1400.

The I/O components 1402 may include a wide variety of components to receive input, provide output, produce output, transmit information, exchange information, capture measurements, and so on. The specific I/O components 1402 that are included in a particular machine will depend on the type of machine. For example, portable machines such as mobile phones may include a touch input device or other such input mechanisms, while a headless server machine will likely not include such a touch input device. It will be appreciated that the I/O components 1402 may include many other components that are not shown in FIG. 14. In various examples, the I/O components 1402 may include user output components 1426 and user input components 1428. The user output components 1426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1402 may include biometric components 1430, motion components 1432, environmental components 1434, or position components 1436, among a wide array of other components. For example, the biometric components 1430 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1432 include acceleration sensor components (e.g., accelerometer), gravitation sensor components, rotation sensor components (e.g., gyroscope).

The environmental components 1434 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to the surrounding physical environment.

With respect to cameras, the a client device may have a camera system comprising, for example, front cameras on a front surface of the client device and rear cameras on a rear surface of the client device. The front cameras may, for example, be used to capture still images and video of a user of the client device (e.g., “selfies”). The rear cameras may, for example, be used to capture still images and videos in a more traditional camera mode. In addition to front and rear cameras, the client device may also include a 360° camera for capturing 360° photographs and videos.

Further, the camera system of a client device may include dual rear cameras (e.g., a primary camera as well as a depth-sensing camera), or even triple, quad or penta rear camera configurations on the front and rear sides of the client device. These multiple cameras systems may include a wide camera, an ultra-wide camera, a telephoto camera, a macro camera and a depth sensor, for example.

The position components 1436 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1402 further include communication components 1438 operable to couple the machine 1400 to a network 1422 or devices 1424 via respective coupling or connections. For example, the communication components 1438 may include a network interface component or another suitable device to interface with the network 1422. In further examples, the communication components 1438 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1424 may be another machine or any of a wide variety of peripheral devices (e.g., a peripheral device coupled via a USB).

Moreover, the communication components 1438 may detect identifiers or include components operable to detect identifiers. For example, the communication components 1438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1438, such as location via Internet Protocol (IP) geolocation, location via Wi-Fi® signal triangulation, location via detecting an NFC beacon signal that may indicate a particular location, and so forth.

The various memories (e.g., main memory 1414, static memory 1416, and memory of the processors 1404) and storage unit 1418 may store one or more sets of instructions and data structures (e.g., software) embodying or used by any one or more of the methodologies or functions described herein. These instructions (e.g., the instructions 1410), when executed by processors 1404, cause various operations to implement the disclosed examples.

The instructions 1410 may be transmitted or received over the network 1422, using a transmission medium, via a network interface device (e.g., a network interface component included in the communication components 1438) and using any one of several well-known transfer protocols (e.g., hypertext transfer protocol (HTTP)). Similarly, the instructions 1410 may be transmitted or received using a transmission medium via a coupling (e.g., a peer-to-peer coupling) to the devices 1424.

### SOFTWARE ARCHITECTURE

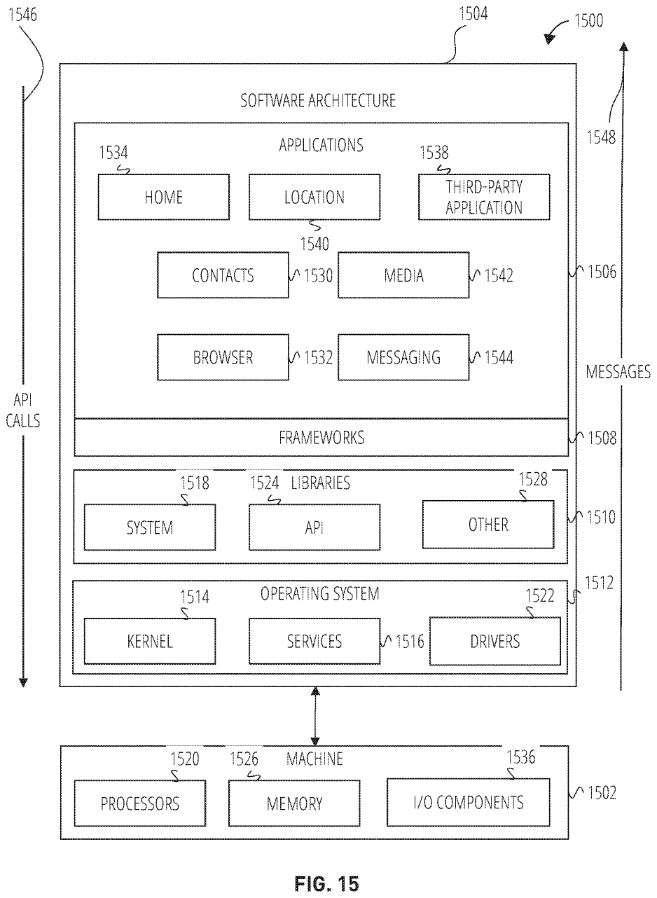

FIG. 15 is a block diagram 1500 illustrating a software architecture 1504, which can be installed on any one or more of the devices described herein. The software architecture 1504 is supported by hardware such as a machine 1502 that includes processors 1520, memory 1526, and I/O components 1536. In this example, the software architecture 1504 can be conceptualized as a stack of layers, where each layer provides a particular functionality. The software architecture 1504 includes layers such as an operating system 1512, libraries 1510, frameworks 1508, and applications 1506. Operationally, the applications 1506 invoke API calls 1546 through the software stack and receive messages 1548 in response to the API calls 1546.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, processor management (e.g., scheduling), component management, networking, and security settings, among other functionalities. The services 1516 can provide other common services for the other software layers. The drivers 1522 are responsible for controlling or interfacing with the underlying hardware. For instance, the drivers 1522 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1510 provide a common low-level infrastructure used by the applications 1506. The libraries 1510 can include system libraries 1518 (e.g., C standard library) that provide functions such as memory allocation functions, string manipulation functions, mathematic functions, and the like. In addition, the libraries 1510 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1510 can also include a wide variety of other libraries 1528 to provide many other APIs to the applications 1506.

The frameworks 1508 provide a common high-level infrastructure that is used by the applications 1506. For example, the frameworks 1508 provide various graphical user interface (GUI) functions, high-level resource management, and high-level location services. The frameworks 1508 can provide a broad spectrum of other APIs that can be used by the applications 1506, some of which may be specific to a particular operating system or platform.

In an example, the applications 1506 may include a home application 1534, a contacts application 1530, a browser application 1532, a location application 1540, a media application 1542, a messaging application 1544, and a broad assortment of other applications such as a third-party application 1538. The applications 1506 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In a specific example, the third-party application 1538 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1538 can invoke the API calls 1546 provided by the operating system 1512 to facilitate functionality described herein.

### GLOSSARY

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1404 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method for end-to-end observability across heterogeneous data platforms, comprising:
receiving monitoring data from a plurality of heterogeneous data platforms, the plurality of heterogeneous data platforms including at least a data pipeline platform and an infrastructure platform;
enriching the received monitoring data with context information associated with the plurality of heterogeneous data platforms;
storing the enriched monitoring data in a unified telemetry store that aggregates telemetry from the plurality of heterogeneous data platforms;
generating, based on the enriched monitoring data stored in the unified telemetry store, an alert associated with a detected condition; and
causing display, in a single view, of unified monitoring information derived from the enriched monitoring data stored in the unified telemetry store.

2. The method of claim 1, wherein the monitoring data comprises real-time monitoring data and batch monitoring data.

3. The method of claim 1, wherein the context information comprises program-specific context information.

4. The method of claim 1, wherein the alert is generated based on one or more configurable rules applied to the enriched monitoring data.

5. The method of claim 4, further comprising detecting a violation of a service level agreement based on the one or more configurable rules.

6. The method of claim 5, further comprising automatically generating an incident ticket based on the detected violation.

7. The method of claim 1, further comprising transmitting notifications associated with the alert through a plurality of configurable channels, the plurality of configurable channels including email notifications and chat notifications.

8. The method of claim 1, further comprising filtering the unified monitoring information based on a user role.

9. The method of claim 8, wherein the user role comprises one of an executive persona and an operations persona, and wherein the single view differs based on the user role.

10. The method of claim 1, further comprising tracking data lineage of the monitoring data across multiple hops within the plurality of heterogeneous data platforms.

11. The method of claim 10, further comprising identifying a source of the detected condition based on the tracked data lineage.

12. The method of claim 1, further comprising executing an automated self-healing action to remediate the detected condition.

13. The method of claim 12, wherein the automated self-healing action comprises scaling up application workloads by allocating additional compute resources.

14. A system comprising:
at least one processor;
at least one memory component storing instructions that, when executed by the at least one processor, cause the at least one processor to perform operations comprising:
receiving monitoring data from a plurality of heterogeneous data platforms, the plurality of heterogeneous data platforms including at least a data pipeline platform and an infrastructure platform;
enriching the received monitoring data with context information associated with the plurality of heterogeneous data platforms;
storing the enriched monitoring data in a unified telemetry store that aggregates telemetry from the plurality of heterogeneous data platforms;
generating, based on the enriched monitoring data stored in the unified telemetry store, an alert associated with a detected condition; and
causing display, in a single view, of unified monitoring information derived from the enriched monitoring data stored in the unified telemetry store.

15. The system of claim 14, wherein the monitoring data comprises real-time monitoring data and batch monitoring data.

16. The system of claim 14, wherein the context information comprises program-specific context information.

17. The system of claim 14, wherein the alert is generated based on one or more configurable rules applied to the enriched monitoring data.

18. The system of claim 17, the operations further comprising detecting a violation of a service level agreement based on the one or more configurable rules.

19. The system of claim 18, the operations further comprising automatically generating an incident ticket based on the detected violation.

20. A non-transitory computer-readable storage medium storing instructions that, when executed by at least one processor, cause the at least one processor to perform operations comprising:
receiving monitoring data from a plurality of heterogeneous data platforms, the plurality of heterogeneous data platforms including at least a data pipeline platform and an infrastructure platform;
enriching the received monitoring data with context information associated with the plurality of heterogeneous data platforms;
storing the enriched monitoring data in a unified telemetry store that aggregates telemetry from the plurality of heterogeneous data platforms;
generating, based on the enriched monitoring data stored in the unified telemetry store, an alert associated with a detected condition; and
causing display, in a single view, of unified monitoring information derived from the enriched monitoring data stored in the unified telemetry store.
